(19) United States
(12) Patent Application Publication
(10) Pub. No.: US 2013/0251884 A1
(43) Pub. Date: Sep. 26, 2013

(54) VEGETABLE AND FRUIT JUICE POWDER

(71) Applicants: Timothy Langrish, Oatley (AU); Shuosi Wang, Padstow (AU)

(72) Inventors: Timothy Langrish, Oatley (AU); Shuosi Wang, Padstow (AU)

(21) Appl. No.: 13/813,067

(22) PCT Filed: Jul. 29, 2011
(86) PCT No.: PCT/AU2011/000961

§ 371 Date: May 21, 2013

(30) Foreign Application Priority Data
Jul. 29, 2010 (AU) 2010903409

(51) Int. Cl. A23L 1/00

(52) U.S. Cl. CPC A23L 1/0029
USPC 426/616; 426/640; 426/506

(57) ABSTRACT

A powder food product comprising one or more fruit components or one or more vegetable components or combination thereof together with an amount of whey protein isolate effective to encapsulate the one or more fruit components or one or more vegetable components or combination thereof.

### CROSS-REFERENCE TO RELATED APPLICATIONS

The present application claims priority from AU 2010903409 the content of which is incorporated herein by reference.

### FIELD OF THE INVENTION

The present invention relates to vegetable powders and fruit juice powders and a process for making the powders.

### BACKGROUND OF THE INVENTION

### Commercial Orange Juice Production Process and Production Forms

Freshly extracted orange juice is filtered through a finisher (screen) where the pulp and seeds are removed, and along with the peel, diverted to be used for by-products. At this stage, the juice is generally made into one of two product forms: bulk frozen concentrated orange juice (FCOJ) or not-from-concentrate (NFC).

### (i) Bulk FCOJ

Juice made into bulk FCOJ is sent to an evaporator where vacuum and heat are used to remove excess water in order to obtain a base concentrate of 65° brix, which is a seven-to-one strength ratio to normal single-strength juice. The bulk FCOJ is then stored at 20° F. or lower until it is sold or packaged for sale. Bulk FCOJ is packaged by orange juice marketers into either frozen concentrated orange juice or chilled reconstituted (recon) ready-to-serve (RTS) orange juice. Packaged FCOJ is made by adding single-strength juice or water and flavour oils and essences to bulk FCOJ to reduce it from 65° brix to 42° brix, which is a four-to-one strength ratio to normal single-strength juice. To convert this FCOJ into ready-to-drink orange juice, consumers thaw it and then mix it with three parts water.

Reconstituted RTS juice is made by adding water and flavour oils and essences to bulk FCOJ to reduce it from 65° brix to 11.8° brix, pasteurizing it, packaging it in cardboard cartons or glass containers and selling it as chilled reconstituted orange juice.

### (ii) NFC

Juice made into NFC is de-oiled to 0.02%-0.04% oil levels with a centrifuge, then either pasteurized, chilled and packaged or stored for future sale and/or packaging. NFC is usually stored as frozen as blocks, or pasteurized and chilled.

### Powdered Food Products

Powdered food products are generally useful and advantageous compared to their liquid counter-parts as they have increased shelf life, decreased volume/weight, decreased packaging and are easier to handle and transport. Besides, this iysical state provides a stable, natural, easily dosable ingredient which generally finds usage in many foods and pharmaceutical products.

Spray drying is a common method of manufacture for dehydrated liquid foods where the moisture is quickly removed resulting in mostly amorphous solid or a powder.

The dehydration of fruit and vegetable juices however is particularly difficult. The chemical composition of fruit and vegetables is complex. Fruit juices and purees contain approximately 90% dry material comprising a mixture of hydrocarbons; monosaccharides, (glucose, fructose), and disaccharides (saccharose and polysaccharides). To these substances are added nitrogen containing substances, organic acids such as citric, malic, tartaric acid, etc, polyphenyl substances, and vitamins. The presence of acids presents yet another complication, and that is pH.

With a mixture of glucose and fructose, fruit juices and purees have low glass transition temperatures. While glucose has a glass transition temperature of about 31° C., fructose has a glass transition temperature of only about 5° C. The temperatures used during spray drying manufacturing processes are likely to be higher than the glass transition temperatures of the food product. This leads to problems during spray drying in controlling the drying time, adhesion to dryer wall, removal of the product from the dryer, caking and subsequently handling of the product. This in turn leads to reduced product stability, decreased yields and potentially spray-dryer operating problems.

Fruit juices and purees are also hygroscopic and tend to absorb moisture from surroundings. The absorption of water leads to the rise of particles sticking together and to the dryer wall during spray drying.

To address these problems drying aids having high T_{g} values are added to the food product. Drying aids reduce overall stickiness of products such as fruit juices by raising the T_{g} value. However, additives fundamentally change the nature of the products and increase the cost of the product. Currently, the most commonly used drying aids are high molecular weight carbohydrates such as maltodextrin, which are used at concentrations up to 65% of the final product.

Experiments described by Roustapour et al., [An Experimental Investigation of Lime Juice Drying in a Pilot Plant Spray Dryer Drying Technology, 24:181-188, 2006] with lime juice illustrate the difficulty of spray drying fruit juice. Roustapour disclose that one of the major problems with lime juice is that it consists of invert sugars and citric acid which have low glass transition temperatures. Due to this characteristic, the particles stick on the dry wall upon their collision method. As a result, drying of these materials is very difficult. In order to solve this problem various percentages of silicone dioxide and maltodextran based on total soluble solid content of lime juice have been used to reach a suitable drying condition. A cool chamber wall spray dried was used in order to decrease the probability of particle stickiness on the wall. Investigation revealed that an addition of 10% silicone dioxide and 20% maltodextran to lime juice is the optimum amount for a complete and successful drying of lime juice.

Other additives and complex manufacturing processes are described for example in U.S. Pat. No. 4,281,026. This US patent describes a process for producing a fruit preparation from a natural fruit juice, where the process comprises removing water from the juice by flowing the juice on a heated, reciprocable, inclinable surface to reduce the water content to 10 to 25% by volume. A crystalline modifying agent is then added to the product. The modifying agent and the product are then blended while heating them.

The heating and blending is continued until the water content of the product is in the range of 1 to 15% by volume.

Any discussion of documents, acts, materials, devices, articles or the like which has been included in the present specification is not to be taken as an admission that any or all of these matters form part of the prior art base or were common general knowledge in the field relevant to the present invention as it existed before the priority date of each claim of this application.

### SUMMARY OF THE INVENTION

In work leading to the present invention, the inventors investigated the encapsulation efficiency of proteins, hybrid additives including proteins and polysaccharide, and the surface activity of proteins and polysaccharide when used to encapsulate powdered vegetable and fruit food products.

Surprisingly the inventors found that whey protein isolates or hybrid additives including whey protein isolates and maltodextrin provide a superior encapsulating agent for a fruit and/or vegetable powder product. The inventors also found that quail egg white protein acts as a better encapsulating agent then why protein isolates. In particular the inventors investigated the use of these proteins using spray drying techniques.

The primary advantage of using these proteins as encapsulating agents was found to be their potential ability to dominate powder surfaces at low concentrations (in preferred embodiments, the concentration is from about 0.5 wt % to about 30 wt %). This is dramatically lower than the concentrations currently used with alternated encapsulating agents such as maltodextrin (˜60 wt %). This advantage presents further benefits, such as reduction in costs due to using smaller quantities of additives, as well as minimal alteration to the flavour and texture of food materials.

Disclosed herein is a powder food product comprising fruit, vegetable or combination thereof together with a whey protein isolate. Accordingly the product comprises a fruit and/or vegetable core together with, or encapsulated by, whey protein isolate. The whey protein isolate may encapsulate the fruit and/or vegetable core or the whey protein isolate may act as a carrier. The whey protein isolate can also be referred to as a coating, outer-layer, wall or film.

Accordingly, in a first aspect, the present invention provides a powder food product comprising one or more fruit components or one or more vegetable components or combinations thereof together with an amount of whey protein isolate effective to encapsulate the one or more fruit components or one or more vegetable components or combinations thereof.

Said another way, the invention provides a food product comprising one or more fruit components or one or more vegetable components or combinations thereof together with an amount of a whey protein isolate effective to encapsulate the one or more fruit components or one or more vegetable components or combinations thereof, wherein the food product is in powder form.

In one example the powder food product can be reconstituted, and accordingly the reconstituted form of the product is within the scope of the inventive product.

Accordingly, in a third aspect, the invention provides use of a powder food product according to the first aspect in the preparation of a reconstituted food product.

In a fourth aspect, the present invention provides use of a whey protein isolate in the preparation of a powder food product comprising one or more fruit components or one or more vegetable components or combinations thereof. Preferably the whey protein isolate is used in an amount effective to encapsulate the one or more fruit components or one or more vegetable components or combinations thereof.

Also disclosed herein is a method of manufacturing a powder food product comprising a whey protein isolate and a fruit or vegetable or combination thereof.

Accordingly, in a fifth aspect, the present invention provides a method of manufacturing a powder food product comprising a whey protein isolate and one or more fruit components or one or more vegetable components or combinations thereof, the method comprising preparing a solution of one or more fruit and/or vegetable juices and whey protein isolate and spray drying the solution to form the powder food product.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be understood that the “one or more fruit components” are derived from one or more fruits and the “one or more vegetable components” are derived from one or more vegetables. The term “fruit components” includes components derived from any number of parts of the fruit including but not limited to the juice, pulp, husk, rind, skin, oils and any other component of the fruit. Similarly, the term “vegetable components” includes components derived from any number of parts of the vegetable including but not limited to the juice, pulp, husk, rind, skin, oils and any other component of the vegetable. In a preferred embodiment, the “fruit components” and “vegetable components” are derived from the juice, extracts, derivatives and/or distillates of the fruit and vegetable components.

The fruit can (for example) be selected from the group comprising citrus fruits (preferably clementine, lime, grapefruit, mandarin, tangerine, kumquat, minneola, tangelo, lemon, orange and pummelo, etc), apples, guavas, mangoes, berries (eg blueberries blackberries, mulberries, strawberries, cranberries and gooseberries), bananas, lychees, pineapples, tomatoes, melons, peaches, nectarines, grapes, zucchini, figs, pears, melons, dates, papaya, persimmons, plums and apricots. etc or any combination thereof. This group is not exhaustive. Citrus fruits, as indicated above, and apples are particularly preferred. More preferred examples of citrus fruits are oranges, lemons, mandarins, tangerines and grapefruit. Preferably the fruit is selected from oranges and/or apples. Mixtures of any fruits especially with oranges and/or apples are contemplated.

Low-acid foods (less acidic) have pH values higher than about 5 and up to about 6.9. Non-acidic or alkaline foods have pH values of 7.0 or greater. Fruits that are less acidic include for example figs, Asian pears, melons, bananas, dates, papaya, ripe pineapple and persimmons. In one embodiment of the invention, at least one of the one or more fruit components is derived from one or more fruits having a pH of higher than about 5.

Highly acidic foods have a pH of less than about 5. In one embodiment of the invention at least one of the one or more fruit components is derived from a fruit having a low pH of less than about 5. In one example the fruit has a pH as low as 2. Described herein are fruits having a pH of about 2.5-5, about pH 3-5, about 3.5-5, about 4-5. Fruits that are highly acidic include for example apples, apricots, blueberries, cranberries, gooseberries, plums and citrus fruits including oranges, grapefruit and lemons.

Preferably the powder food product described herein includes at least one fruit solid derived from a high acidic fruit, that is, a fruit having a low pH. Most preferably the fruit is apple or a citrus fruit having a low pH. In one example, the fruit is an orange. In another example, the fruit is apple. In another example it is two or more fruits at least one of which has a low pH. In one example the powder food product comprises orange components and at least one other fruit components.

The term “vegetable” is understood to refer to a plant cultivated for an edible part, such as the root of the beet, the leaf of spinach, or the flower buds of broccoli or cauliflower. All vegetables are included within the scope of the invention. This can include fungi such as mushrooms. Preferred vegetables are those that can be juiced, for example, celery, carrots, beetroot, ginger, spinach, zucchini or any combination thereof. This group is not exhaustive.

Almost all vegetables are either low acid or non-acidic.

Accordingly, in one embodiment of the first aspect of the invention there is provided a powder food product comprising vegetable components together with a whey protein isolate. For example the vegetable is selected from the group comprising celery, carrots, beetroot, ginger, spinach, or any combination thereof.

### Powder Product

The powder food product of the invention is in powder form. The food product of the invention may be a fruit powder product, a vegetable powder product or a fruit and vegetable powder product.

In one embodiment, there is disclosed a powder food product comprising one or more fruit components together with one or more vegetable components. Any combination of fruit components and/or vegetable components is envisaged. In one example the fruit and vegetable components are derived from a fruit that has high acidity and a vegetable has low acidity or is non-acidic.

In one example the combination comprises orange components and one or more vegetable components. In another example, the combination comprises apple components and one or more vegetable components.

The fruit and vegetable powder products are preferably suitable for reconstitution. Preferably with water, but can be with other liquid. In various examples the fruit and vegetable powders can be used to make a fruit and/or vegetable drink, soft drinks, liquid stock or other liquid. In other examples the powders can be used in powder form as flavourings, powder stock, drug coatings, tableting, confectionary, cake mixes, biscuit mixes. The powder can also be pressed into tablet form.

Described herein are powder food products which preferably comprise ≧40% w/w and ≦99% fruit components, vegetable components or mixture thereof. Preferably the powder food products comprise ≧45% w/w fruit components, vegetable components or mixture thereof, preferably ≧50% w/w fruit components, vegetable components or mixture thereof, preferably ≧55% w/w fruit components, vegetable components or mixture thereof, more preferably ≧60% w/w fruit components, vegetable components or mixture thereof, more preferably ≧65% w/w fruit components, vegetable components or mixture thereof, more preferably ≧70% w/w, and ≦99% fruit components, vegetable components or mixture thereof. Most preferably the food product comprises ≧75% w/w fruit components, vegetable components or mixture thereof, preferably ≧80% w/w fruit components, vegetable components or mixture thereof, preferably ≧85% w/w fruit components, vegetable components or mixture thereof, preferably ≧90% w/w fruit components, vegetable components or mixture thereof, preferably ≧95% w/w, and ≦99% fruit components, vegetable components or mixtures thereof.

In one embodiment, the fruit and/or vegetable components are solids and/or oils.

Examples of the invention include a range of fruit components and vegetable components such as for example about 40% w/w, about 70% w/w, about 80% w/w, about 90% w/w, about 95% w/w, about 98% w/w and about 99% w/w fruit components, vegetable components or mixture thereof.

Whey protein isolate (which may be referred to hereinafter as “WPI”) refers to a mixture of globular proteins isolated from whey. Whey proteins are low molecular weight proteins isolated from dairy proteins. As described herein, the whey protein isolate may be used as a carrier or an encapsulating agent.

According to the first aspect of the invention, the powder food product described herein comprises an amount of whey protein isolate effective to encapsulate the one or more fruit components and/or vegetable components. Therefore, according to the first aspect of the invention, the whey protein isolate acts as an encapsulating agent by encapsulating the fruit components and/or vegetable components.

The food product described herein preferably comprises 50% or less whey protein isolate content. Preferably the lower limit of whey protein isolate is 0.01% w/w. For example the whey protein isolate content is ≦50% w/w, preferably ≦45% w/w, preferably ≦40% w/w, preferably ≦35% w/w, preferably ≦30% w/w, preferably ≦25% w/w, preferably ≦20% w/w, preferably ≦15% w/w, preferably ≦10% w/w, preferably ≦5% w/w, preferably ≦4% w/w, preferably ≦3% w/w, preferably ≦2% w/w, preferably ≦1% w/w, preferably ≦0.5% w/w, and ≧0.01% w/w.

The food product described herein comprises an amount of whey protein isolate that is more than 0% w/w, that is, there is at least some protein. Preferably the upper limit of whey protein isolate is 50% w/w. Preferably the amount of protein is ≧0.01% w/w, preferably ≧0.02% w/w, preferably ≧0.05% w/w, preferably ≧0.75% w/w, preferably ≧0.1% w/w, preferably ≧0.2% w/w, preferably ≧0.3% w/w, preferably ≧0.4% w/w, preferably ≧0.5% w/w, preferably ≧0.6% w/w, preferably ≧0.7% w/w preferably ≧0.8% w/w, preferably ≧0.9% w/w, preferably ≧1% w/w, wherein the amount is ≦50% w/w.

Most preferably the amount of whey protein isolate is about 0.01-50% w/w, preferably about 0.02-45% w/w, preferably about 0.05-40% w/w, preferably about 0.75-35% w/w, preferably about 0.1-30% w/w, preferably about 0.2-30% w/w, preferably about 0.3-30% w/w, preferably about 0.4-30% w/w, preferably about 0.5-30% w/w, preferably about 0.6-30% w/w, preferably about 0.7-30% w/w, preferably about 0.8-30% w/w, preferably about 0.9-30% w/w, preferably about 1.0-30% w/w, preferably about 0.1-25% w/w, preferably about 0.2-25% w/w, preferably about 0.3-25% w/w, preferably about 0.4-25% w/w, preferably about 0.5-25% w/w, preferably about 0.6-25% w/w, preferably about 0.7-25% w/w, preferably about 0.8-25% w/w, preferably about 0.9-25% w/w, preferably about 1.0-25% w/w, preferably about 0.1-20% w/w, preferably about 0.2-20% w/w, preferably about 0.3-20% w/w, preferably about 0.4-20% w/w, preferably about 0.5-20% w/w, preferably about 0.6-20% w/w, preferably about 0.7-20% w/w, preferably about 0.8-20% w/w, preferably about 0.9-20% w/w, preferably about 1.0-20% w/w.

In one embodiment, the whey protein isolate is the sole additive in the powder food product of the invention.

In preferred embodiments, the amount of whey protein isolate is about 0.5% w/w-10%% w/w, preferably 0.5-5% w/w, more preferably 0.5-2% w/w. In one example the whey protein isolate content is about 0.5% w/w. In another example the whey protein isolate content is about 1.0% w/w, in another example the whey protein isolate content is about 2.5% w/w, in another example the whey protein isolate content is 5.0% w/w, in another example the whey protein isolate content is 10% w/w. Preferably, the fruit components are derived from oranges, preferably orange juice.

In a preferred embodiment, the amount of whey protein isolate is about 20-50% w/w, preferably about 20-45% w/w, preferably, 20-40% w/w, preferably, 20-35% w/w, preferably 20-30% w/w, preferably 20-25% w/w, preferably about 20% w/w. Preferably, the fruit components are derived from apples, preferably apple juice. One or more other extraneous additives can be included in the powder food product of the present invention including but not limited to of maltodextrin, gum arabic or any preservative. In one preferred embodiment, maltodextrin can is included. The advantage of the present invention is that these additives are not required and can be avoided. That is, described herein are food powder products that most preferably exclude additives such as maltodextrin. The inventors have found however, that inclusion of whey protein isolate in combination with other additives, such as maltodextrin, can provide favourable yields of the powder food product to above 60%, which meets the industry requirements. In particular the inventors have found that relative small quantities of other additives, such as maltodextrin, are required when used in combination with whey protein isolate.

The powder food product of the invention may further comprises an amount of extraneous additive that is ≦about 50% w/w, preferably ≦about 45% w/w, preferably ≦about 40% w/w, preferably ≦about 35% w/w, preferably ≦about 30% w/w, preferably ≦about 25% w/w, preferably ≦about 20% w/w, preferably ≦about 15% w/w, preferably ≦about 10% w/w, preferably ≦about 5% w/w, preferably ≦about 4% w/w, preferably ≦about 3% w/w, preferably ≦about 2% w/w, preferably ≦about 1% w/w, most preferably ≦about 0.5% w/w, ≦about 0.1% w/w. Preferably the lower limit of the further extraneous additive is 0.01% w/w. In one embodiment it is present in non-detectable amounts.

Preferably, the food product comprises extraneous additive in an amount of about 0.01-20% w/w, preferably about 0.1-15% w/w, preferably about 0.2-10% w/w, preferably about 0.4-8% w/w, preferably about 0.5-5% w/w, preferably about 5% w/w, preferably about 2.5% w/w, more preferably about 1% w/w most preferably about 0.5% w/w. In one preferred embodiment the extraneous additive is maltodextrin,

Preferably, the powder food product comprises about 0.5 to 20% w/w maltodextrin and about 0.05 to 20% w/w whey protein isolate. Preferably, the juice components are derived from oranges or apples.

In one embodiment, the total amount of additive is about 1-10% w/w. Preferably, the additives include only whey protein isolate and maltodextrin. In one preferred embodiment, the powder food product comprises 0.5 to 5% w/w maltodextrin and 0.5 to 5% w/w whey protein isolate. In these embodiments, the juice components is preferably derived from oranges. The inventors have found that additives in amount of 1-10% w/w is effective in providing a powder food product containing orange components, that has favourable characteristics, such as lack of stickiness as determined by a high yield following spray drying.

In particularly preferred embodiments, there are provided powder food products containing orange components that comprise:

i) about 0.5% w/w maltodextrin and about 0.5% w/w whey protein isolate,
ii) about 1% w/w maltodextrin and about 1% w/w whey protein isolate,
iii) about 2.5% w/w maltodextrin and about 2.5% w/w whey protein isolate
iv) about 5% w/w maltodextrin and about 5% w/w whey protein isolate,
v) 0% w/w maltodextrin and about 1% w/w whey protein isolate.

In yet another embodiment of the invention, the powder food product comprises 1 to 20% w/w maltodextrin and 1 to 20% w/w whey protein isolate. In this embodiment, the juice component is preferably derived from apples. The inventors have found that additives in a total amount of about 20% w/w is effective in providing a powder food product containing apple components, that has favourable characteristics, such as lack of stickiness as determined by a high yield following spray drying. Preferably, the total amount of additive is about 20% w/w. Preferably, the additives include only whey protein isolate and maltodextrin.

In particularly preferred embodiments, there are provided powder food products containing apple components that comprises

i) about 19% w/w maltodextrin and about 1% w/w whey protein isolate,
ii) about 15% w/w maltodextrin and about 5% w/w whey protein isolate,
iii) about 10% w/w maltodextrin and about 10% w/w whey protein isolate,
iv) about 5% w/w maltodextrin and about 15% w/w whey protein isolate,
v) about 5% w/w maltodextrin and about 15% w/w whey protein isolate,
vi) about 1% w/w maltodextrin and about 19% w/w whey protein isolate or
v) 0% w/w maltodextrin and about 20% whey protein isolate.

In another embodiment of the invention the powder food product comprises about 50% w/w maltodextrin and about 10% whey protein isolate. In another example the product is produced comprising 20% maltodextrin and 10% whey protein isolate. In yet more examples a product is produced comprising 5.0%, 2.5%, 1.0, and 0.5% each of maltodextrin and 20, 15, 10% or less whey protein isolate.

It will be understood that an additive is not restricted to maltodextrin and can include other additives, such as for example, gum arabic or any preservative. Maltodextrin, if present at all, can be in a resistant form. This has added health benefits.

Moreover many other additives can be included in the final product for which the powder food product is intended. If for example the powder is to be pressed into a tablet then the person skilled in the art will recognise that suitable excipients will be required.

### Methods of Manufacture

Methods of manufacture refer to methods of microencapsulation that are suitable for making food powders. Microencapsulation methods are selected from the group including spray drying, spray cooling and chilling, fluidized bed coating, extrusion, freeze drying and co-crystallization.

In one particular example the method for making the powder comprises spray drying.

According to the fourth aspect of the invention, there is provided a method for manufacturing a food powder product comprising fruit components, vegetable components or combination thereof the method comprising preparing a solution of fruit and/or vegetable juice and whey protein isolate and spray drying the solution to form a powder.

In one example the solution is prepared by dissolving the whey protein isolate in water then mixing the solubilised protein with fruit or vegetable juice. Preferably the water is at room temperature (˜22 degrees C.-26 degrees C.).

In another example the whey protein isolate is not first dissolved in water. Preferably the solution is prepared by dissolving the whey protein isolate in juice. Preferably the juice is at room temperature (˜22 degrees C.-26 degrees C.).

In one example the method includes extracting the juice from the fruit or vegetable. In another example the method does not include extracting the juice from the fruit or vegetable. The juice per se can be obtained from a third party. The juice can be in concentrated form or in non-concentrated form.

In one example the juice is treated to remove pulp and other solids. In another example the juice is not treated to remove pulp and other solids. The total solids content of the juice can be measured by methods well known in the art. In one example the method comprises determining the total solids content of the juice.

In one example the solution of protein and fruit juice is fed into a spray drying machine with an inlet temperature of about 100-230 degrees C. Preferably the inlet temperature is about 130-220 degrees C., more preferably 160-190 degrees C. In one example the inlet temperature is about 130 degrees C.

In one example the outlet temperature is about 80-120 degrees C. Preferably the outlet temperature is about 100 degrees C.

### BRIEF DESCRIPTION OF THE FIGURES

FIG. 1: Effect of the presence of different proteins on recovery compared with currently used maltodextrin (control: 40 wt % orange juice to 60 wt % maltodextrin) and pure orange juice. Vertical bars indicate the standard deviations.

FIG. 2: Comparison of different protein yield profiles with constant protein concentration of 10 wt % up to 80 wt % orange juice followed by 5, 2.5, 1 and 0.5 wt % for 90, 95, 98 and 99 wt % orange juice, respectively, with remainder maltodextrin. Vertical bars indicate standard deviation.

FIG. 3: Effect of orange juice concentration on yield in the presence of casein.

FIG. 4: Effect of orange juice concentration on yield in the presence of whey protein isolate.

FIG. 5: Effect of maltodextrin concentration and whey protein isolate presence on yield. Vertical bars indicate standard deviations.

FIG. 6: Effect of whey protein isolate concentration on yield. Vertical bars indicate standard deviations.

FIG. 7: Solubility of proteins in orange juice (batch 2, pH˜4).

FIG. 8: Suggested course during spray drying of sprayed droplets in A: in the absence of surface active material and fat; B: in the presence of surface active material, but no fat

FIG. 9: Average DSC thermograms of 100% orange juice, 100% whey protein isolate, and samples of 99% orange juice: 0.5% M: 0.5% whey protein isolate, and 99% orange juice: 1% whey protein isolate.

FIG. 10: The order of stickiness during spray drying (Bhandari and Howes, 1999; Liu et al., 2006; Huntington and Stein, 2001).

FIG. 11: Comparison of the yield profiles with different additives, including MD, WPI and the combinations of MD and WPI. (Vertical bars for 40 AJ:50 MD:10 WPI indicate the overall standard deviations)

FIG. 12: Effect of the concentration of total additives on the recover. (Vertical bars indicate the standard deviations from uncertainties discussion)

FIG. 13: Effect of different combinations of WPI and MD on the yield with a constant total concentration of WPI and MD. (Vertical bars indicate the standard deviations from uncertainties discussion).

FIG. 14: Mechanistic explanation for surface activity of different hybrid additives of WPI and MD.

FIG. 15: Effect of increasing maltodextrin concentration from 0 to 5% on spray-drying yield in the presence of WPI.

### DETAILED DESCRIPTION OF THE INVENTION

The invention described is a powder food product comprising a fruit, vegetable components or a combination thereof together with an effective amount of whey protein isolate. The inventors found surprisingly whey protein isolates are particularly effective microencapsulating agents for fruits (especially highly acidic fruits) and vegetables in methods of spray drying.

### Fruits and Vegetables

In broad terms, a fruit is understood to mean a structure of a plant that contains seeds. The term can have different meanings depending on the context. In food preparation this normally means the fleshy seed-associated structures of certain plants that are sweet and edible in the raw state, such as for example apples, oranges, grapes, strawberries, berries and bananas, or the similar-looking structures in other plants, even if they are non-edible or non-sweet in the raw state, such as lemons and olives. Seed-associated structures that do not fit these informal criteria are usually called by other names, such as vegetables.

Citrus fruits are acidic fruits. Citrus fruits are a good source of vitamin C for a balanced diet and the immune system. They also contain organic acids (citric, malic, and lactic acids). Citrus fruit include for example clementine, lime, grapefruit, mandarin, tangerine, kumquat, minneola, tangelo, lemon, orange and pummelo etc.

In one example the composition comprises at least one citrus fruit. In one example the citrus fruit comprises an orange.

Citrus foods such as oranges and lemons are considered to be highly acidic or to have a low pH of less than pH 4.6. Oranges have a pH of about pH 3.3-4.2, lemons have a pH of about pH 3-3.7, and grapefruit have a pH of about pH 2.2-2.4.

The invention described is particularly useful for highly acidic fruits.

Other highly acidic fruits include for example apples (pH about 3.3-3.9), cranberries, and blackberries.

The pH of various fruits and vegetables are provided in Table 1. It will be appreciated that the pH's are only approximate and examples will exist outside of the ranges.

TABLE 1

| Product | Approximate pH |
|---|---|
| Apples | 2.9-3.9 |
| Apricots | 3.3-4.8 |
| Apricots, canned | 3.4-3.8 |
| Apricots, nectar | 3.8 |
| Artichokes | 5.5-6.0 |
| Asparagus | 6.0-6.7 |
| Avocados | 6.3-6.6 |
| Bananas | 4.5-5.2 |
| Beans | 5.6-6.5 |
| Beets | 5.3-6.6 |
| Blackberries | 3.9-4.5 |
| Blueberries | 3.1-3.4 |
| Beets | 4.9-5.5 |
| Broccoli, cooked | 5.3 |
| Cabbage | 5.2-5.4 |
| Cactus | 4.7 |
| Capers | 6.0 |
| Carrots | 5.9-6.3 |
| Celery | 5.7-6.0 |
| Cherries | 3.2-4.5 |
| Coconut | 5.5-7.8 |
| Corn | 5.9-7.3 |
| Cranberry juice | 2.3-2.5 |
| Dates | 6.5-8.5 |
| Gooseberries | 2.8-3.1 |
| Grapefruit | 3.0-3.7 |
| Grapes | 3.5-4.5 |
| Leeks | 5.5-6.2 |
| Lemons | 2.2-2.4 |
| Limes | 1.8-2.0 |
| Mangos | 5.8-6.0 |
| Melons | 6.0-6.7 |
| Nectarines | 3.9-4.2 |
| Olives, green, fermented | 3.6-3.6 |
| Olives, black | 6.0-7.0 |
| Oranges | 3.3-4.2 |
| Peaches | 3.4-4.1 |
| Pears | 3.6-4.0 |
| Peas | 5.8-6.4 |
| Pickles, sour | 3.0-3.4 |
| Pickles, dill | 3.2-3.6 |
| Pimento | 4.6-5.2 |
| Plums | 2.8-3.0 |
| Potatoes | 5.6-6.0 |
| Pumpkin | 4.8-5.2 |
| Raspberries | 3.2-3.6 |
| Rhubarb | 3.1-3.2 |
| Sauerkraut | 3.4-3.6 |
| Spinach | 5.5-6.8 |
| Squash | 5.0-5.4 |
| Strawberries | 3.0-3.9 |
| Sweet potatoes | 5.3-5.6 |
| Tomatoes | 4.3-4.9 |
| Turnips | 5.2-5.6 |
| Vegetable juice | 3.9-4.3 |
| Watermelon | 5.2-5.6 |

The “one or more fruit components” are derived from one or more fruits and the “one or more vegetable components” are derived from one or more vegetables. The term “fruit components” includes components derived from any number of parts of the fruit including but not limited to the juice, pulp, husk, rind, skin, oils and any other component of the fruit. Similarly, the term “vegetable components” includes components derived from any number of parts of the vegetable including but not limited to the juice, pulp, husk, rind, skin, oils and any other component of the vegetable. In a preferred embodiment, the “fruit components” and “vegetable components” are derived from the juice, extracts, derivatives and/or distillates of the fruit and vegetable components.

Accordingly, the fruit and vegetable powder products may be prepared from the primary juice product with or without pulp or other solids. It is not necessary to screen the product to remove solids. The juice to be prepared as a powder product can be an untreated or raw product or it can be a treated product, such as for example a fruit and/or vegetable juice concentrate, or reconstituted form of juice. Alternatively it may be a cooked product.

### Whey Protein Isolate

Whey proteins are globular proteins that are isolated from whey. A mixture of betalactoglobulin, alpha-lactalbumin and serum albumin are usually present. The typical ranges of molecular weights are 18000 g/mol and less.

The preferred food product described here comprises an effective amount of whey protein isolate (WPI). The term “effective amount” refers to an amount that is effective to encapsulate the fruit and/or vegetable components which form the core. The preferred amounts of WPI have been hereinbefore defined.

### Microencapsulation

Microencapsulation is a “packaging” technique by which liquid droplets or solid particles are packed. The structure formed by the microencapsulating agent around the microencapsulation material (the core) can be referred to as the wall system. The wall protects the core against deterioration, limits the evaporation (or losses) of volatile core materials, and releases the core under desired conditions. The wall can also be referred to as an outer layer, or surface layer, or coating or film.

A number of microencapsulation methods have been developed including spray drying, spray cooling and chilling, fluidized bed coating, extrusion, freeze drying and co-crystallization. Spray drying is the most commonly used encapsulation technique in the food industry. The process of spray drying is economical and flexible, uses equipment that is readily available, and produces powder particles of good quality.

Good microencapsulating agents should be a good film former, have low viscosity at high solids levels, exhibit low hygroscopicity, provide good flavour when reconstituted, be low in cost, bland in taste, stable in supply and afford good protection to the product to be encapsulated.

Described here is the use of whey protein isolate as a microencapsulating agent. The microencapsulating agent forms a film around a core, being the fruit and/or vegetable components.

### Methods of Spray Drying

Spray drying involves atomization of a liquid feed into a drying medium, resulting in an extremely rapid evaporation of solvent (e.g. water). Drying proceeds until the desired level of water content in the product is achieved (generally between 3 and 1%). The process is controlled by means of the product feed and air flow (flow and temperature). The advantages of spray drying include the following: a) the powder specifications remain constant throughout the dryer when drying conditions are held constant; b) it is a continuous and easy drying operation that is adaptable to full automatic control; and c) a wide range of dryer designs are available to suit a variety of applications, especially for dehydration of heat-sensitive materials.

Atomization results from the dispersion of a liquid feed once pumped through either a nozzle at a very high pressure or through a rotary atomizer, which spins at a very high speed. The feed travels through the dryer according to the relative positions of the nozzle/atomizer and air inlet, and depending on this configuration the flow can be co-current, counter-current, or mixed. The versatility of the spray-drying operation is demonstrated, for example, by the different ways by which the bulk density of the final powder can be increased: a) increasing the feed rate; b) increasing the powder temperature; c) increasing the solids content of the feed; d) atomization through a rotary atomizer; and e) use of counter-current configuration.

### Powder Product

The powder is a fine particle product with a particle size determined by the atomization nozzle. In one example, the particle size is between about 5 and 30 micrometers in diameter. In alternate examples the particle size is larger.

Most preferably the coated or encapsulated particles substantially lack stickiness. This is demonstrated by a high yield from spray drying. Preferably the powder appears to be dry visually, and preferably the powders appear to be adequately free flowing.

Preferably the product has crystalline characteristics such as sorption stability.

### EXAMPLES

### Example 1

### Applications of Whey Protein Isolate (WPI) and Maltodextrin as Spray Drying Additive to Produce Orange Juice Powder

### Background—Protein Solubility

Protein solubility is a function of many factors, such as native or denatured state and environmental factors (i.e. pH, temperature). The pH of the solution affects the nature and the distribution of the protein's net charge. Generally, proteins are more soluble in low (acids) or high (alkaline) pH values because of the excess charges of the same sign, producing repulse among the molecules and, consequently, contributing to its largest solubility. A protein usually has the least solubility at the isoelectric point (pI). Values of pH above and below the pI where a protein has a net negative charge contribute to greater solubility.

Accordingly the use of proteins as spray-drying aids poses some issues such as solubility, sensitivity of proteins to pH changes as well as heat. This is particularly relevant when the pH of the initial fruit juice is close to the pI of the protein. When this happens the protein will decrease in solubility and lose its encapsulating properties. Furthermore the thermal stability of proteins is also an important factor due to the high temperatures involved in spray drying, as well as its effect on protein solubility and functionality.

Denaturation of proteins are likely to occur when proteins are exposed to heat over time. This process occurs due to temperature effects on the secondary and tertiary structures through the stabilisation on non-covalent bonds. When these bonds are broken, the secondary and tertiary structures unfold, exposing hydrophobic groups, leading to aggregation, coagulation, and precipitation, which decrease protein solubility. The effects of pH and temperature on solubility significantly effect functionality.

In working leading to the present invention the inventors have explored the use of three proteins (i) casein and caseinates, (ii) whey proteins and (iii) soy proteins.

### (1) Casein and Caseinates

The solubility of casein is at a minimum near its pI of 4.6. The solubility of casein is better at pH values less than 3.5. Casein and caseinates are highly heat stable, withstanding heating at 150 degrees C. for 1 hour, although other factors, such as pH and ionic strength can reduce heat stability.

### (ii) Whey Proteins

The solubility of whey protein isolates is influenced by both pH and temperature. The solubility of whey proteins is minimum at its pI of 4.5. Whey protein isolates have varying solubilities across the pH range.

Unlike caseins, whey protein is susceptible to heat denaturation. Heating of whey protein stabilised emulsions at 90 degrees C. for 10 minutes results in denaturation and has undesirable effects on emulsion particle size. This susceptibility to heat denaturation makes an issue of their use as potential aids in spray drying, where increasing protein concentration accelerate the degree and rate of denaturation.

(iii) Soy Proteins

With an isoelectric point of 4.5 the minimum solubility of soy protein isolate, soy protein hydrolysates, and soy protein occurs between pH 4.0 and 5.0. Poor solubility of soy proteins is inherited from their main protein components, glycinin and β-conglycinin, which have pH and ionic strength dependent quaternary structures.

Furthermore, glycinin, a component of soy proteins, begins to denature at around 60-90° C. and β-conglycinin starts to denature at only 60-75° C. Although minimal experimental work exists on investigating soybean proteins as coating agents, they possess similar solubility to casein and temperature dependent properties to whey proteins, indicating similar functionality.

TABLE 2

| Protein | Denaturation Conditions | Isoelectric Point (pI) |
|---|---|---|
| Caseins | Very heat stable, | 4.6 |
| | not easily denatured | [Soluble pH <3.5 |
| | | or pH >5.5] |
| Whey | Denature when heated over | 4.5 |
| Proteins | time, e.g. 90° C. for 10 min | [least soluble at pH |
| | | 4.5 and pH 6.8] |
| Soy | Begins to denature | 4.5 |
| Proteins | around 60-90° C. | [Minimum solubility |
| | | between pH 4.0-5.0] |

It can be seen that the pI values for each of the proteins are very similar, and hence it is expected that they can be applied to the same types of fruit juices. However, the effectiveness of these proteins as potential drying aids may vary due to changes in the solubility and hence functionality in spray drying of mildly acidic fruit juices.

### Experimental Work

### Materials

Fresh orange juice (Original Juice Co. Black Label Chilled Juice: Orange Pulp Free 1.5 L) was purchased from a local supermarket, in Sydney, Australia, with specified ingredients of orange juice 99.9%, vitamin C (300).

Maltodextrin (MDX-18) was obtained from Deltrex Chemical.

Proteins: Casein—VWR International Ltd., Poole, England
Whey Protein Isolate—Fitlife; and
Soy protein acid hydrolysate—Sigma SL07192.

All water used was potable tap water from the Sydney mains.

All chemicals used in this study were of reagent grade.

### Solution Preparation:

Measure solids content (% by weight) of fruit juice.
Beaker with 200 ml tap water at room temperature varied from 22° C. to 26° C.
Used 29.705 g±0.0001 g fruit juice solids (as a fruit juice solution, e.g. if the fruit juice has 10% solids by weight, use 297.05 g fruit juice) and 0.305 g±0.0001 g of WPI for 99% fruit juice: 1% WPI mixer measured with balance AB204-S
Powder was stirred in water until dissolved—approx 10-20 minutes.

### Spray Dryer (Called Milo) Buchi-B290 Settings:

Chamber diameter 0.15 m; length 0.48 m
Inlet air temperature: 130° C.
Aspirator rate: 100% (≈38 m³/h)
Pump rate: 23% (4.5 ml/min)
Nozzle cleaner: 9 pulses
Nozzle air flow rate: (473 l/hr)
A typical outlet temperature is around 100° C.

### Summary of Method Steps:

Measured weight of empty product container with ANDGF6100
Measured relative humidity and the actual mixing ratio of the laboratory air
Assembled drying chamber, cyclone, product container, nozzle and separation flask
Connect pipes from the pump, the inlet air stream and the nozzle cleaner to nozzle before turning on the equipment (followed steps from the user manual)
Proved all connections to make air tight
Turned on aspirator (main air fan), turned on heater, set rotameter (followed steps from user manual)
Waited until inlet temperature and outlet temperature stable, proved connections again of tightness before turning on pump with just water
Waited until outlet temperature stable
Warm up took approximately 30 to 35 min
Changed water to sample solution
Solution was pumped through the spray dryer after approximately 24 min
Cleaned pipe with water and followed cleaning process of user manual before turning of the pump and the heater
Let equipment cool down until outlet temperature below 60° C.
Measured weight of full product container for calculating the yield
Stored product in small glass bottle
Turned off aspirator and started dissembling the drying chamber, cyclone, nuzzle and separation flask
Cleaned spray dryer parts
After 1 hour cooling turned off aspirator and switched off equipment

### Detailed Description of Experimental Methodology

Spray-drying experiments were performed with at least two repeats where results were of interest. The spray dryer was situated in a laboratory with stable environmental conditions for performing all experiments. Before starting experiments, the wet bulb and dry bulb temperatures were measured. The ambient air temperature was measured to be about 20-25° C. and the relative humidity of the air in the room was recorded to be between 60-75% at room temperature.

The experimental control for spray drying orange juice was chosen to be solution containing 60 wt % maltodextrin to 40 wt % orange juice. Casein, whey protein isolate and SPAH, were investigated at a constant protein concentration of 10 wt % with variations in maltodextrin and orange juice concentrations as shown in Table 3.

Preliminary results indicated that whey protein isolate has the potential to perform better than casein and SPAH as an enhancer to spray drying fruit and vegetable juices. Experiments were then performed to investigate the optimum concentration of whey protein isolate as enhancer to spray drying of orange juice and this was achieved by spray drying solutions with protein concentrations of 5.0, 2.5, 1.0 and 0.5 wt % with equal amounts of maltodextrin to obtain orange juice concentrations up to 99 wt %. This is also shown in Table 3 below.

TABLE 3
Compositions of the solutions used
for the spray drying experiments

| Protein type: Casein as C, | | | |
|---|---|---|---|
| Whey Protein Isolate as | Orange | Malto- | |
| WPI and SPAH as S | juice % | dextrin % | Protein % |
| C, WPI, S | 40 | 50 | 10 |
| C, WPI, S | 70 | 20 | 10 |
| WPI | 90 | 5.0 | 5.0 |
| WPI | 95 | 2.5 | 2.5 |
| WPI | 98 | 1.0 | 1.0 |
| WPI | 99 | 0.5 | 0.5 |

### Feed Solution Preparation

The orange juice was filtered through a fine tea strainer to remove pulp residue, so as to ensure the tubing and/or spray nozzle did not block during spray drying. The juice was stored in a refrigerator when not in use. The filtering step is not expected to be essential to a commercial set-up.

Feed solutions were prepared by adding protein in powder form and/or maltodextrin on a weight basis relative to the orange juice used, excluding the addition of water as a solvent, and stirred for at least 30 minutes before spray drying. Analyses of the orange juice were carried out to determine the pH and total soluble solid content.

### Total Soluble Solid Content

A Petri dish of known weight (ANDGF-6100 model balance) containing a known amount of orange juice was placed in an oven (Thermoline Scientific Dehydrating Oven) at 100° C. for a period of 24 hours. The Petri dish was then re-weighed after cooling in a dessicator where the final weight indicated the total weight of soluble solids present, allowing the total soluble solid content to be determined per gram of orange juice.

### Spray Drying

A Büchi Mini Spray Dryer (Model B-290, Büchi Laboratoriums-Technik, Flawil, Switzerland), in suction mode, was used for the spray-drying process.

Spray drying was carried out at an aspirator rate of 38 m³/h, pump rate of 9.2±0.4 ml/min, nozzle air flow of 473 L/h, and nozzle cleaner at 9 pulses for all experiments.

### Yield Calculation

All spray-drying results were primarily reported as recovery or yield (%), as a measure of how successful a run was by the powder produced as a percentage of that expected. This was chosen as a means of comparison for indication of stickiness, i.e. reduced stickiness and hence decreased wall deposition within the drying chamber achieves higher yields. A good yield is considered to be in the range of 60 to 70% recovery of powdered product, as this is a minimum expectation in practice, where anything greater can be considered a significant improvement.

The absolute yield was used as a measure of comparison, allowing for the moisture content to be taken into account. This was determined as a percentage of expected powder collected to the dry product actually obtained from spray drying. First the total amount of solids in the feed solution was calculated by adding the mass of maltodextrin, protein, and the soluble solids per gram of orange juice multiplied by the amount of orange juice present in the feed solution. The expected amount of powder obtained was determined by dividing the total solution made up by the total solids within the feed solution, giving the expected amount of solids for that solution. Hence the amount of powder expected to be collected during spray drying was determined by the equation,

$$EP = \frac{M + P + OJ \times TSS}{M + P + OJ + W} \times spray \text{-} dried feed solution ( g )$$

### Where,

EP = expected powder product (g)
M = maltodextrin mass (g)
P = protein mass (g)
OJ = orange juice mass (g)
W = mass of water (g)
TSS = total soluble solid per
g orange juice (g/g)

The absolute yield was then calculated using the following relationship, where M₀ refers to the dry basis moisture content as a weight fraction.

$$yield = \frac{actual powder collected}{expected powder product} \times ( \frac{1}{1 - {M}_{0}} ) \times 100 \%$$

### Moisture Content

Immediately after spray drying, a sample of approximately 0.5 g was placed in a pre-weighed (Mettler Toledo AB204-S balance) clean dry glass container and then placed in an oven (Thermoline Scientific Dehydrating Oven) set at 100° C. for 24 hours. The container was then removed and re-weighed after cooling in a dessicator to determine the amount of moisture lost. Moisture content was calculated on a dry matter basis,

$$Moisture content ( \% ) = \frac{{M}_{W} - {M}_{D}}{{M}_{D} - {M}_{C}} \times 100 \%$$

### Where,

M_{W} = mass of wet sample, container and lid (g)
M_{D} = mass of dry sample, container and lid (g)
M_{C} = mass of container and lid (g)

### Analysis of Powder Structure

Spray-dried powders were analysed for their powder structure. All samples from spray drying were either used immediately or stored in zip-lock bags at 4° C. in dark until the analysis stage. Modulated differential scanning calorimetry (MDSC) using a DSC Q1000 (TA Instruments) was performed to analyse the final powder product. At least four samples of approximately 3 mg (Mettler Toledo AB204-S balance) were placed into a hermetic dish and lid, where the final weight sample weight was recorded. The samples were then placed into the DSC, with modulation temperature amplitude of ±1° C., a modulation period of 60 seconds, a ramp rate of 5° C./min, over a temperature range of 0 to 300° C. The resulting sample thermograms were then analysed for evidence of amorphous and/or crystalline properties, and compared against the DSC thermograms of spray-dried whey protein isolate and pure orange juice to determine the contributing components of the properties observed in the samples.

### Solubility of Proteins at Different pH

The solubility of each of the proteins in juice solutions at different pH was determined. The pH of the feed solution was measured by using a pH meter (Orion Research, digital pH/millivolt meter 611) before protein was added. The solubility of each protein is then measured by mixing 2.0 g of protein in 100 g of orange juice for 1 hour. The resulting mixture was then filtered through a fine tea strainer to remove any undissolved protein and then placed into an oven (Thermoline Scientific Dehydrating Oven) at 100° C. for 24 hours, allowed to cool in a dessicator and re-weighed. Solubility was then calculated as grams soluble protein per 100 g of protein in solution. This was done by subtracting the initial weight of the sample, Petri dish and total soluble solids present in the orange juice from the final weight of the sample and Petri dish after drying to find the amount of soluble protein, which was then taken as a percentage of the initial amount of protein added.

### Results and Discussion—Preliminary Experiments

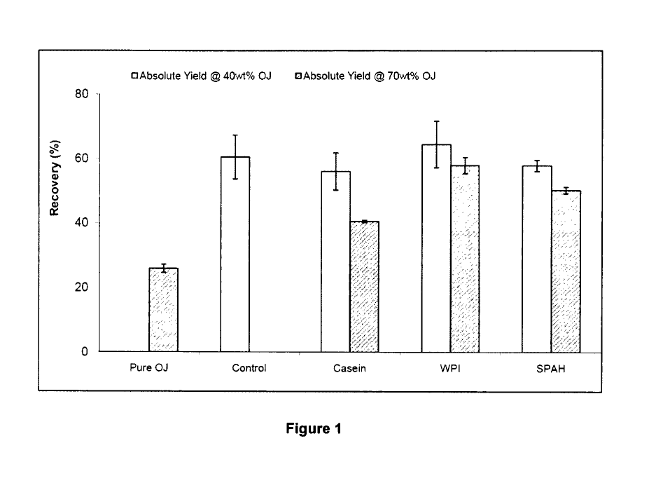

Preliminary experiments on spray drying orange juice involved comparing and determining the most promising protein to use as a spray-drying additive to reduce the current required maltodextrin concentration. Results were consistent in showing the addition of drying aids, such as maltodextrin and combinations of maltodextrin and protein, significantly improved yield in comparison to pure orange juice yields (p<<0.01), indicating that stickiness and hence wall deposition was successful reduced. These results are described in the table below and summarised in FIG. 1.

Controls of 40 wt % orange juice 60 wt % maltodextrin, with an average absolute yield of 62±7%, and pure orange juice with an average absolute yield of 26±1%, were found to reflect general industrial practice and literature values.

TABLE 4
Comparison of absolute yields (%) in the presence of protein.

| | | | Whey | |
|---|---|---|---|---|
| | | | Protein | |
| Solution (wt %) | Repeat | Casein | Isolate | SPAH |
| 40 OJ:50 M:10 P | Average | 58 | 66 | 61 |
| | Standard | 6 | 7 | 2 |
| | Deviation | | | |
| 70 OJ:20 M:10 P | Average | 44.1 | 61 | 54 |
| | Standard | 0.4 | 3 | 1 |
| | Deviation | | | |

Comparing absolute yield values, at 40% OJ all of the proteins all looked to provide reasonable product. However at 70% OJ a more surprising result was obtained—whey protein isolate looked to be the most promising protein for spray drying orange juice.

The addition of 60 wt % maltodextrin (control) or any other maltodextrin and protein combination improved the spray-drying yields of orange juice. However, casein had a significantly lower yield at the higher orange juice concentration than the two other proteins, in comparison with the 60 wt % maltodextrin control (p<0.01).

These initial experiments allowed the comparison of the currently used maltodextrin concentration and pure orange juice yields with those containing protein, and hence the identification of the most promising protein for spray drying orange juice.

The profiles of each protein with respect to increasing orange juice concentration were further investigated to obtain a clear image of each protein's drying-aid capabilities.

### Expansion of Experiments to Increase Orange Juice Concentration

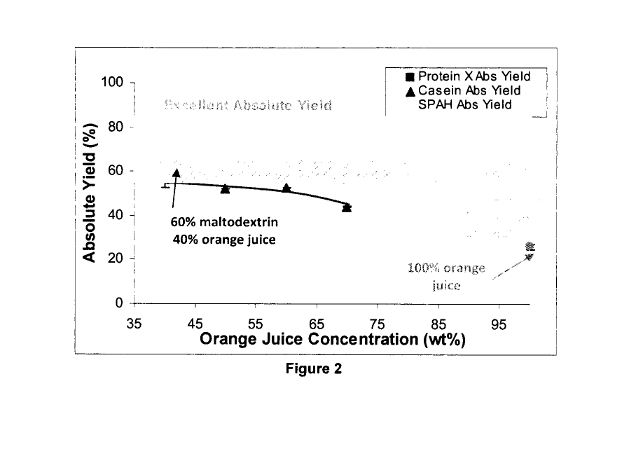

The proteins were further investigated with respect to increasing orange juice concentrations (FIG. 2). In comparison with both casein and SPAH, whey protein isolate showed the most significant results, particularly at higher orange juice concentrations.

The following sections further describe the individual profiles of each of the proteins and the links between these results to current literature and relevant proposed mechanisms.

### Casein

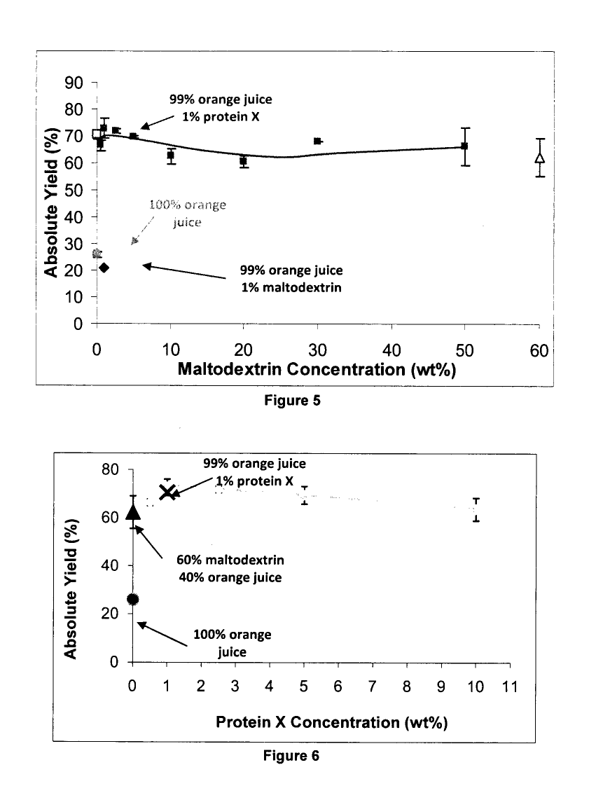

Generally, increasing the orange juice concentration, whilst maintaining a 10 wt % casein concentration, led to a gradual decrease in both absolute yield supported by a R2 value of 0.80 (FIG. 5), and actual product yield where a poor average yield of 47.2±0.1% was observed for 70 wt % orange juice and 20 wt % maltodextrin. This poor result may be due to casein being observed to remain undissolved in the orange juice indicating poor solubility by observation, since large amounts of casein settled to the bottom and/or coagulated at the top of the solution, hence explaining the poorer yields due to the poorer observed solubilities. This was surprising since previous experimental work by the inventors showed casein was effective in improving lactose spray-drying yields and more so than whey protein isolate.

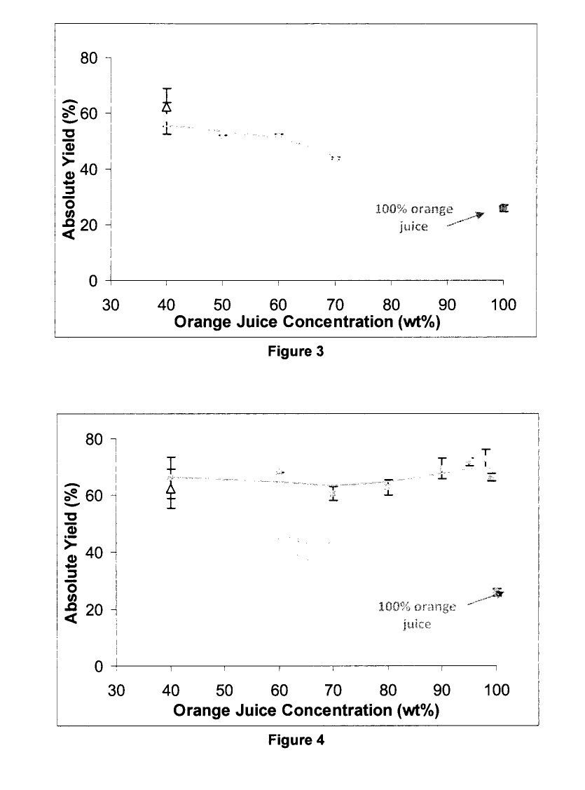

The experimental results shown in FIG. 3, however, are contrary to this where the yield decreased as the orange juice concentration was increased. This may be due to the fact that orange juice and lactose solutions have very different characteristics. Orange juice has a composition which is more complex (it is a complex mixture of fructose; glucose, sucrose, citric acid, asorbic acid, polyphenolic antioxidants and minerals and other parts) and lactose is a simple sugar. The pH of orange juice is low, while the pH of simple sugars is neutral.

The results observed in FIG. 3 are also different to previous success with sodium caseinate by other researchers. The use of casein instead of sodium caseinate may also explain the poor results obtained due to their differences in solubility as well as the bulk materials used.

### Soy Protein Acid Hydrolysate

Results show that the presence of SPAH gives better absolute yields of spray-dried orange juice powder (FIGS. 1 and 2) in comparison to casein, although slightly decreasing with increasing orange juice concentration. SPAR was also observed to be more soluble in the orange juice, compared to casein, which once again indicating a potential link between protein surface coating ability and its solubility in the stock solution. Although, yields obtained were similar to those of whey protein isolate, the higher moisture content of these powders meant that a lower absolute yield was observed for SPAH.

Moreover, during the experiments it was observed that SPAH exhibited a distinct ‘meaty’ smell and brown colour, which modified the resulting orange juice powder product by changing its visual, fragrance and flavour quality. This would make it unappealing to potential consumers due to the loss of the juice's natural characteristics. Due to these unpleasant effects SPAR has on the spray dried juice powders, SPAH was found to be unsuitable to be used as an additive to spray drying juice powders and was not investigated further.

### Whey Protein Isolate

In the preliminary experiments, solutions with whey protein isolate concentrations of 10 wt % were investigated with different concentrations of maltodextrin and orange juice to compare its effectiveness as spray drying additive to casein and SPAH. Both whey protein isolate and SPAR exhibited higher yields than casein. It was also observed that SPAR gave unpleasant characteristics to the spray dried juice powders. Thus further experiments were then conducted with whey protein isolate to explore the possibility of producing spray dried orange juice powders with less additives added. This was done by spray drying solutions with equal portions of whey protein isolate and maltodextrin, at 5, 2.5, 1.0 and 0.5 wt %, to give 90, 95, 98, 99 wt % orange juice concentrations, respectively.

These experiments gave rise to average yields as high as 84% for 95 wt % orange juice with 2.5 wt % maltodextrin and 2.5 wt % whey protein isolate. Similar to SPAH, whey protein isolate was also observed to readily dissolve in the orange juice.

Orange juice concentration seemed to have almost no effect on absolute yield (FIG. 4), supported by p>0.01 and an R² value of 0.10, indicating that approximately 10% of the variation in absolute yield can be explained by the orange juice concentration where the remaining 90% can be explained by other variables or inherent variability.

The effect of maltodextrin concentration (FIG. 5) was investigated to find out if maltodextrin was required in the feed solution to act as a matrix for the protein to effectively coat the droplet surfaces. It was observed that lower maltodextrin concentrations generally gave no effect on yields. This was supported by the regression analysis which gave an R2 value of 0.06, indicating that maltodextrin concentration had no significant effect on absolute yield (p>0.01). That is, the presence of maltodextrin had no beneficial effect on absolute yield, reflected in experiments with no added maltodextrin (99% orange juice and 1% WPI) obtaining similar absolute yields to those with maltodextrin present (p>0.01).

Therefore, since no significant increase in absolute yield was observed with higher maltodextrin concentrations, the presence of a maltodextrin matrix may possibly hinder the surface coating ability of the whey protein isolate by reducing the difference between maltodextrin and whey protein isolate diffusion rates. Since a smaller difference in diffusion rates would lead to both the protein and maltodextrin migrating to the centre of the droplet at similar rates during drying, reducing the amount of protein left on the droplet surface.

On the other hand, whey protein isolate concentration was observed to play more of a role in absolute yield than orange juice and maltodextrin concentrations (FIG. 5), where a R² value of 0.29 was obtained from regression analysis and a p-value of less than 0.01 from ANOVA. Lower concentrations, approaching 1 wt % whey protein isolate seemed to increase absolute yield, until a slight drop at 0.5 wt % was observed, indicating that further lowering the whey protein isolate concentration would probably reduce the absolute yield. However, all absolute yields containing whey protein isolate showed improvement over both the absolute yields of pure orange juice and standard mixture of 40% orange juice with 60% maltodextrin. See FIG. 6.

From the results discussed above whey protein isolate was found to act as a successful drying aid for spray drying orange juice at low concentrations. The significant results obtained are summarised in Table 5, which also includes yields for pure orange juice and 40% orange juice with 60% maltodextrin for comparison.

TABLE 5
Summary and comparison of significant
whey protein isolate results.

| Composition (wt %) | | | | |
|---|---|---|---|---|
| Orange | | | Average | |
| Juice | Maltodextrin | WPI | Yield (%) | Error* |
| 100 | — | — | 32.4 | 2.5 |
| 40 | 60 | — | 65.3 | 7.1 |
| 98 | 1 | 1 | 83.4 | 3.8 |
| 99 | 1 | — | 24.7 | — |
| | 0.5 | 0.5 | 77.3 | 1.8 |
| | — | 1 | 82.2 | 1.9 |

*error reported as one standard deviation.

These results clearly met the project's aim of using proteins to improve the yield of spray drying fruit juices at concentrations lower than those currently used with maltodextrin. Table 5 shows that the yield of pure orange juice was approximately 32%, which is much lower than that required by the industry (>60%), hence spray drying cannot successfully convert pure orange juice droplets into amorphous powder under the operating conditions chosen for this work. 60 wt % of maltodextrin added was found to improve the yield considerably. These observations are supported by previous studies, where no powdered orange juice is produced from spray drying under similar drying conditions and that the addition of maltodextrin allows good yields to be obtained.

Our results consistently shows that a >60% yield of spray drying of orange juice can be obtained by using whey protein isolate at much lower concentration than that is required of maltodextrin. The mixture containing 1% whey protein isolate and 99% orange juice increased yield significantly to approximately 82%. Considering that a recovery of greater than 60% is considered to be a good criteria for successful spray drying, the addition of 1 wt % of whey protein isolate to the feed has improved the yield of spray drying orange juice more than that achieved by 60 wt % of maltodextrin.

### Solubility

Protein solubility was investigated due to the proposed link between protein solubility and its effectiveness as a drying aid in spray drying orange juice. This was achieved through first predicting the solubility of each protein investigated in the actual orange juice used in this work and comparing this with the previously mentioned compatibility with fruit juices by measuring the pH of the feed solutions. The solubility was then determined for each protein within one of the orange juice batch samples used, where these values were then compared with literature values.

### Solution pH

The pH of the feed solution was measured before the addition of protein to provide a clear indication of whether the protein would be soluble in it or not. This was done since the addition of protein would modify the pH of the feed solution. The pH values of each of the pure orange juice batches used and some of the initial feed solutions used are summarised in Table 6.

TABLE 6
Solution pH values before the addition of protein.

| | | Average pH ± Standard | |
|---|---|---|---|
| Solution (wt %) | Batch | Deviation | Variation* |
| 100 OJ | 1 | 3.66 ± 0.25 | — |
| | 2 | 3.99 ± 0.01 | — |
| | 3 | 4.19 ± 0.09 | — |
| 40 OJ:60 M | 1 | 4.06 ± 0.04 | +0.40 |
| | 2 | 4.19 ± 0.09 | +0.20 |
| 40 OJ:50 M | 1 | 3.83 ± 0.21 | +0.18 |
| | 2 | 4.01 ± 0.15 | +0.02 |
| 70 OJ:20 M | 1 | 3.77 ± 0.02 | +0.11 |
| | 2 | 4.03 ± 0.08 | +0.04 |

*variation from same pure orange juice batch due to addition of maltodextrin and water

The pH values obtained for each of the three batches on orange juice used are consistent with the approximate pH of 3.3-4.2 for orange juice. These results also showed that the addition of maltodextrin and water to orange juice to prepare the feed solutions increased the pH, clearly seen by the positive variation from the corresponding pure orange juice batch.

### Solubility Tests

Solubility tests were performed using the second batch of pure orange juice, which had an average pH value of approximately 4.0.

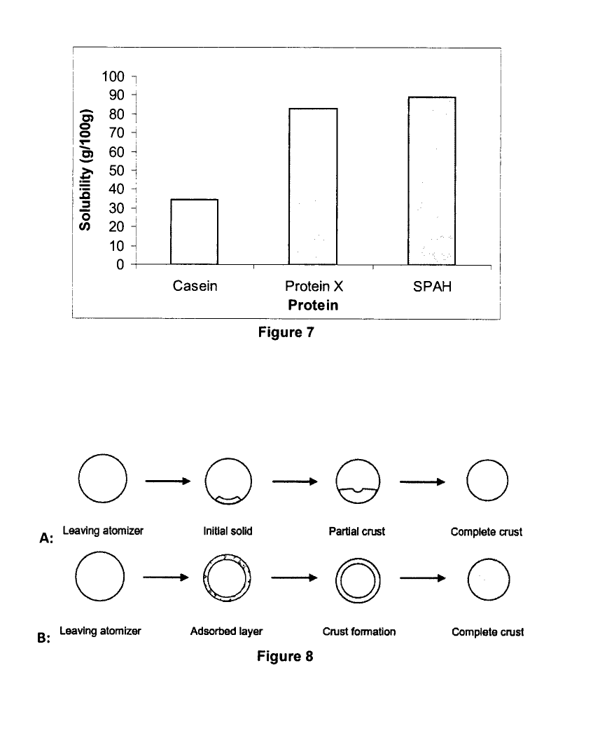

From these results, it is observed that different proteins dissolved in orange juice to different extents, where both WPI and SPAH were able to be dissolved in orange juice easily, with solubilities greater than 80 g/100 g (FIG. 7). Casein was found to be the least soluble, with a solubility of approximately 35 g/100 g.

### Possible Mechanistic Explanation

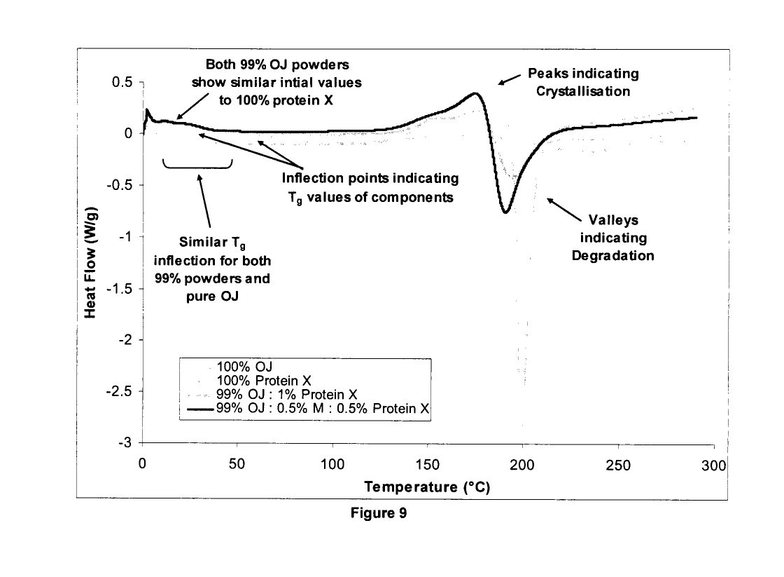

One hypothesis for the effectiveness of protein as a coating is that it precipitates on the surface of particles to form the coatings. (See FIG. 8A) If this were true, then less soluble proteins might be thought to be more effective than insoluble ones. The present experiments suggest that this is not the case. Instead the experiment suggests the mechanism for coating is the process of migration of proteins to the droplet surfaces as well as differences in diffusivity of the different components. (See FIG. 8B).

Therefore, the ability of WPI to increase spray-drying yields of orange juice to greater than 80% and to successfully transform it into a powder could be suggested to involve both its film forming and surface active properties to encapsulate juice components. Hence, the combination of surface active properties of proteins, that is their preferential migration to the air-water interface, along with their film forming properties upon drying, allows for the stickiness of the juice-protein solutions to be overcome through the formation of a protein-rich coating, raising the glass-transition temperature of the surface layer.

### Powder Structure

Powders produced from spray drying a high concentration orange juice (99%) in the presence of whey protein isolate were observed to have crystalline characteristics, such as powder hardness and shine. MDSC was used to confirm these observations. Averaged thermograms of 100% orange juice (batch 3), 100% spray-dried whey protein isolate, and spray-dried samples of 99% orange juice with 0.5% maltodextrin and 0.5% whey protein isolate, and 99% orange juice to 1% whey protein isolate are summarised in FIG. 9, with peak and valley values detailed in Table 9.

The sample crystallinity peaks and degradation valleys observed in the powders seem to be primarily due to orange juice characteristics (FIG. 9), although the size of the peaks and valleys may possibly be dampened by the presence of whey protein isolate, reflected in the higher 1% whey protein isolate samples having slightly flattened peaks and valleys than those of the sample containing 0.5% whey protein isolate (Table 9). Degradation valleys for both powder samples were similar to that of pure orange juice, most likely explained by the high concentration of orange juice present in the powders.

TABLE 9
Summary of thermogram peak and valley
points obtained from MDSC.

| | Crystallisation Peak | | Degradation Valley | |
|---|---|---|---|---|
| Powder | | Heat | | Heat |
| Compositions | Temperature | Flow | Temperature | Flow |
| (wt %) | (° C.) | (W/g) | (° C.) | (W/g) |
| Pure Orange Juice | 180 | 0.40 | 199 | −2.98 |
| Spray-Dried WPl | 170 | −0.02 | 237 | −0.17 |
| 99 OJ:1 WPI | 175 | 0.23 | 194 | −0.42 |
| 99 OJ:0.5 M:0.5 WPl | 174 | 0.37 | 190 | −0.75 |

Sample crystallinity can be determined by quantifying the heat associated with melting (fusion) of the sample. This heat is reported as percent crystallinity by calculating the ratio of the heat of crystallization to the heat of fusion against the heat of fusion for a 100% crystalline sample of the same material, which in this case was assumed to be the pure orange juice since both samples are primarily composed of orange juice. Hence, of the two samples, the one containing whey protein isolate alone showed the least crystallinity (˜58%), while the sample containing both maltodextrin and whey protein isolate showed the greatest crystallinity (˜93%). The difference in crystallinity between the two samples may be due to the amount of whey protein isolate present since the spray-dried whey protein isolate showed the lowest degree of crystallinity compared with that of the pure orange juice. Otherwise, the difference could arise from the presence or absence of maltodextrin between the two samples. Furthermore, both 99% orange juice powders appeared to have similar T_{g} values to that of pure orange juice due to the presence of similar inflections points, while spray-dried whey protein isolate was shown to have a higher T_{g} by the inflection point being around 50° C. compared with 25° C. for the samples containing orange juice.

Therefore, the presence of more whey protein isolate (or the absence of maltodextrin) seemed to decrease the crystallinity of the spray-dried orange juice, whereas the addition of equal parts maltodextrin and whey protein isolate showed no change in crystallinity to that of pure orange juice. Increased crystallinity is a key factor to consider in powders, determining to what extent clumping and caking occurs as well as how well the powder handles and stores. Increased crystallinity is desired to maximise long-term storage stability, including minimizing clumping and caking.

### Conclusion

In the examples it was observed that 1% whey protein isolate was effective to convert fruit juice into an amorphous powder form. The inventors expect 0.5% whey protein isolate will also be effective.

The yield of powder was increased, from 65±7% for currently-used maltodextrin concentrations of 60% and from 32±3% for pure orange juice, to greater than 80% in the presence of low protein concentrations.

Despite being temperature sensitive, the high solubility (83 g/100 g) and low pH sensitivity of whey protein isolate lead to a high product yield above 80% at orange juice concentrations greater than 90 wt %. On the other hand, the poor solubility (35 g/100 g) and high pH sensitivity of casein gave lower yields of 47.2±0.1% at high orange juice concentrations of only 70 wt %. This was not expected.

The results of this work show great promise for the food industry, since it opens a new area of interest involving the successful spray drying of materials, such as fruit juice, which were previously thought to be unsuited to spray drying. This would allow for the year-round demand of fruit juices to be met, along with the need for longer shelf-lives and easier storage, handling and transport. In addition, there is also the potential to reduce the associated costs of current methods, since smaller quantities of additives (0.5-5 wt %) could be used instead of the 50-65 wt % maltodextrin currently required to achieve successful spray drying of fruit juice. This lower additive concentration allows for a higher purity product to be obtained, ensuring the original and natural physicochemical properties of the product are retained, such as texture, flavour and fragrance.

Furthermore, the attributes of whey protein isolate make it an ideal drying aid for spray drying foodstuffs, such as fruit juices, due to its solubility and bland taste over a broad pH range without causing detectable changes in flavour and appearance in drinks prepared with up to 1% of whey protein isolate. This increases the product quality for personal and commercial use and hence makes it very marketable.

### Example 2

### Applications of Whey Protein Isolate (WPI) and Maltodextrin as Spray Drying Additives to Produce Apple Juice Powder

The present inventors have investigated the use of WPI and the additive maltodextrin as spray drying additives for producing apple juice powder in a yield that meets the industry requirement of 60%.

It has previously been reported that that 40% is the maximum orange juice concentration that can be dried in conjunction with a maltodextrin (60%) providing a yield of 78%. The present inventors have now found (as shown in Example 1) that 1% WPI gives a significant improvement to the yield for spray drying orange juice (83 wt % yield) compared with that achieved by using 60% maltodextrin. These two previous results were chosen as the experimental controls for Example 2 (Table 10).

TABLE 10
The typical composition of solution for spray-drying orange
juice. (Orange juice as OJ, Maltodextrin as MD, WPI as WPI)

| Composition of solution (wt %) | Yield (wt %) |
|---|---|
| 40 OJ:60 MD | 78 |
| 99 OJ:1 WPI | 82 |

WPI as a sole spray drying additive for apple juice was initially investigated followed by an investigation of WPI in combination with maltodextrin Optimization of WPI and a new combined additive, including maltodextrin and WPI, was investigated and the combination ratio was optimised to improve the yield further. XPS measurements were utilised to investigate the surface activity of maltodextrin and WPI in spray-dried powder.

### Experimental Work

### Materials

Fresh orange juice and apple juice were purchased from a local supermarket, Coles in Sydney, Australia, and were used for the production of powder from the spray dryer.

Fresh apple juice is Just Juice-Apple Juice (2 Litre) from Berri Limited, with specified ingredients of apple juice 99.9%, acidity regulator (330), vitamin C, flavour. Fresh orange juice is Just Juice-Orange Juice (2 Litre) from Berri Limited, with specified ingredients of orange juice 99.9%, vitamin C, flavour,

Maltodextrin (MDX-18) was obtained from Deltrex Chemical.

Whey Protein Isolate was obtained from Fitlife.

All water used was potable tap water from the Sydney mains.

All chemicals used in this study were of reagent grade.

### Spray Dryer (Called Milo) Buchi-B290 Settings:

As for Example 1

### Summary of Method Steps:

As for Example 1

### Detailed Description of Experimental Methodology

The experimental control for spray drying apple juice was chosen to be a solution containing 60 wt % maltodextrin to 40 wt % orange juice and 1% WPI to 99% orange juice.

Initially experiments were performed to investigate the optimum concentration of whey protein isolate as an enhancer to the spray drying of apple juice and were carried out by spray drying solutions with WPI concentrations as indicated in Table 2. This was followed by investigating the effect of hybrid additives (WPI and MD) and establishing the threshold amount of WPI (alone) required to achieve successful spray drying of apple juice (with >60% yield). These results can be seen below.

### Feed Solution Preparation

As for Example 1 but using apple juice in place of orange juice.

### Total Soluble Solid Content

The total soluble solid content of fruit juice was evaluated for the calculation of final yields from spray drying. It was determined by taking a sample of approximately 20 g fruit juice in a dried and weighted (AND, GF-6100 model balance) Petri dish and placing the sample in an oven (Thermoline Scientific, Dehydrating Oven, Sydney) at 100° C. for a period of 24 hours. Then the Petri dish with the sample was cooled in a desiccator to room temperature and re-weighed. This final weight indicated the total weight of soluble solids present, allowing the total soluble solid content per gram fruit juice to be calculated.

### Spray Drying

A Buchi Mini Spray Dryer (Model. B-290, Buchi Laboratoriums-Technik, Flawil, Switzerland), in suction mode, was used for all spray-drying experiments. Spray drying was carried out at an aspirator rate of 38 m³/h, a pump rate of 4.5 ml/min, a nozzle air flow of 473 L/h, nozzle cleaner at 9 pulses and inlet temperature of 130° C. for all spray-drying experiments. The dryer was run at this condition for about 30 mins before the feed solution was introduced. The spray dryer is located in a laboratory with stable ambient conditions for running all experiments. The condition of atmosphere surrounding was 22° C. dry bulb, 18° C. wet bulb and corresponding relative humidity of 72.7% and absolutely humidity of 0.012 kg/kg. The powder was collected in a pre-weighted glass collector connected at the end of cyclone. The mass of actual powder product was measured from the product in this collector for calculate the yield (collector recovery). The amounts of powder collected in cyclone (cyclone recovery) were also measured by recording the weight difference of cyclone before and after spray-drying process. Total recovery was calculated by adding collector recovery and cyclone recovery. The powders collected from collector after spray-drying process were immediately packed in Glad® resealable plastic bags and stored in a freezer. The experimental uncertainties discussion will be presented later.

### Yield Calculation

Yield or recovery (%) was calculated in a similar way to Example 1.

The absolute yield was determined as percentage of expected powder produced in theory to the actually powder obtained from the collector in spray dryer. The amount of expected powder was expressed by the equation,

$$EP = \frac{A + FJ \times TSS}{A + FJ + W} \times spray \text{-} dried feed solution ( g ) \qquad Equation 1$$

### Where,

A = the total mass of additives (g)
EP = mass of expected powder product (g)
FJ = mass of fruit juice (g)
W = mass of water (g)
TSS = total soluble solid per g fruit juice (g/g)

The absolute yield was then calculated using the following relationship,

$$Yield = \frac{AP}{EP} \times ( \frac{1}{1 + {M}_{0}} ) \times 100 \% \qquad Equation 2$$

### Where,

AP = actual powder product (g)
M₀ = dry basis moisture content as a weight fraction

### Moisture Content

The moisture content was calculated as for Example 1.

### pH Measurement

The pH meter used in this experiment was pHTest 2 Model from Eutech Instruments and Oakton Instruments made in Malaysia. The accuracy of pHTest 2 is ±0.1 pH. The pH of apple juice and orange juice samples were tested in 6 groups with 2 repeats for each group.

### XPS Measurements

X-ray photoelectron spectroscopy (XPS), which is also known as Electron Spectroscopy for Chemical Analysis (ESCA), is a well-established technique for the analysis of solid surfaces. The method using XPS to quantify the different component percentage coverage on the powder surface has been developed at the Institute for Surface Chemistry (Fäldt et al., 1993) and is known in the art. The percentage coverage of the different components on surface of powder can be determined using known methodology through a matrix formula (Fäldt et al., 1993) comparing the fraction of different elements on the surface of the powder to the fraction of elements in the components making up this powder. In XPS system, a soft x-ray beam was used to eject photoelectrons from the near-surface region for most solids surface of a specimen. Because of the restricted mean free path of the photoelectrons in the solids, XPS can provide valuable information on approximately the first 5 nm depth (Briggs and Seah, 1994). XPS was used to investigate the actual surface composition of particles instead of using indirect technique such as scanning electron microscopy. In this particular case, the atomic concentration of carbon, oxygen and nitrogen in the surface of the samples was analysed to determine the percentage coverage of the different components on the powder surface (Fäldt et al., 1993).

The XPS measurements were conducted with an XPS system, model XR 50 High Performance Twin Anode with Focus 500 Monochromator and PHOIBOS 150 MCD hemispherical analyser) produced by Specs® GmbH, in the School of Physics, University of Sydney. The machine used a monochromatic A1 Kx X-ray source. The pressure in the working chamber during the analysis was kept at less than 1×10⁻⁶ Pa. The take-off angle of the photoelectrons was perpendicular to the sample. The analyser operated with a pass energy of 80 eV. The step size was 0.1 eV. The spectrum acquisition time varied, depending on the peak area. The analysed area of the powder was a circle 2.0 mm in diameter on the top layer. The powders were spread on the surface of the graphitic tape without mounting when the ESCA analyses were carried out. After drying, the powders were stored in a freezer and warmed back to room temperature in a desiccator before the XPS test was conducted. Each analysis was repeated 4 times at least. Each representative peak of the principal elements was repeated at least 3 times. Spectra were analysed using the CasaXPS (Version 2.3.14dev38) to calculate the percentage of elements in the surfaces of the samples.

### Surface Composition Calculation

From the XPS measurement results, the area for each peak indicated the amount of atoms for a particular element. This area for each element was calculated by the CasaXPS (Version 2.3.14dev38). Then the mole fractions of each element were calculated by dividing the amount of this element by the total amount of all elements in the surface of sample. Based on the mole frictions of each element in the surface of samples, the surface composition was estimated by two known methods. One was the surface content matrix formula (with O), another one was surface composition calculation without oxygen.

### Results and Discussion

### Preliminary Experiments

In Example 1, the inventors found that WPI significantly improved the yield of spray drying orange juice in comparison with 60 wt % addition of maltodextrin and pure orange juice yields. Preliminary experiments with spray drying apple juice involved comparing and determining whether WPI is an effective spray-drying additive for apple juice, in order to reduce the currently-required maltodextrin concentration of 60% or more.

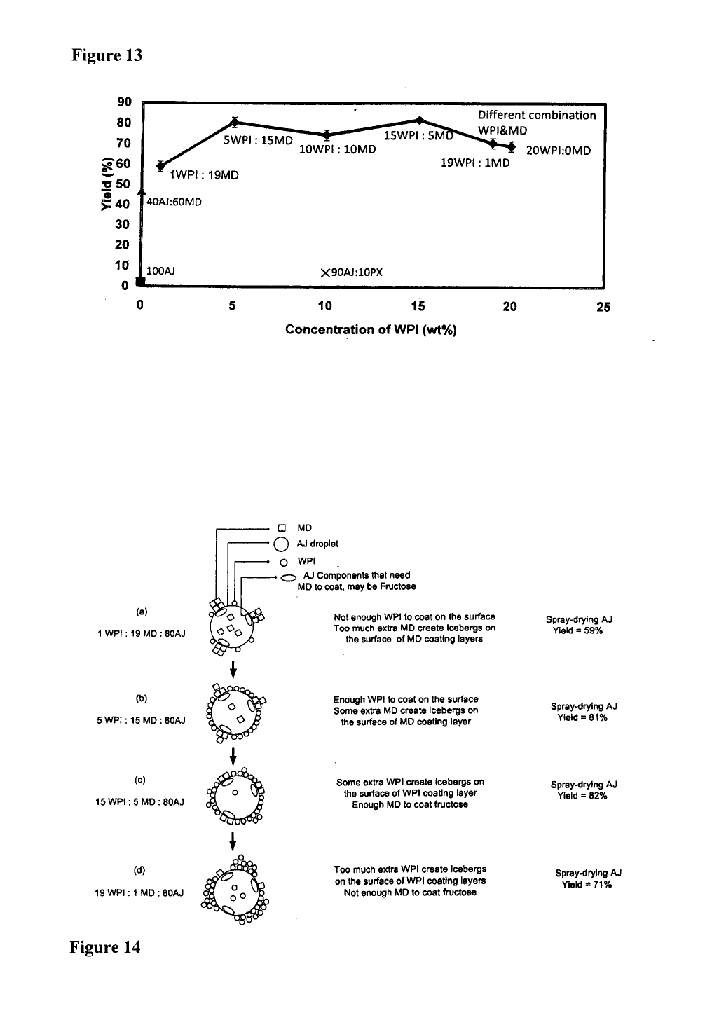

The results in Table 11 and FIG. 13 show that the addition of WPI in an amount of 20 wt % is effective in improving the yield of spray drying of apple juice to 69%. This is not as good as the yield of spray drying orange juice, indicating that the stickiness of apple juice is much more difficult to overcome than that of orange juice. These results are summarised in Table 11.

TABLE 11
Comparison of pure juice and control experiments between
AJ and OJ (Apple juice as AJ, orange juice as OJ, Maltodextrin
as MD, Whey Protein Isolate as WPI.)

| | | Standard | |
|---|---|---|---|
| Composition of | Average Yield | Deviation | |
| Solution (wt %) | (wt %) | (wt %) | Reference |
| 100 AJ | 2 | 1.7 | Example 2 |
| 100 OJ | 44 | 2.0 | Example 2 |
| 40 AJ:60 MD | 47 | 3.0 | Example 2 |
| 40 OJ:60 MD | 65 | 7.1 | Example 1 |
| 99 AJ:1 WPI | 0.1 | — | Example 2 |
| 99 OJ:1 WPI | 82 | 1.9 | Example 1 |
| 90 AJ:10 WPI | 7 | — | Example 2 |
| 80 AJ:20 WPI | 69 | — | Example 2 |
| 80 AJ:5 MD:15 WPI | 82 | — | Example 2 |

In summary, for both pure juices and the two control experiments, apple juice had significantly lower yields than orange juice. The yield of pure apple juice was only 2%, which was far less than the 44% yield with pure orange juice. The addition of 60 wt % maltodextrin improved the spray-drying yields of orange juice to 65%, which is higher than the 60% yields required by industry. However, the same addition of maltodextrin improved the spray-drying yields of apple juice to 47%, which is still lower than the industry requirement of 60%. Furthermore, the addition of 1 wt % protein improved the yield of orange juice, but it made nearly no difference for apple juice compared with the yield from pure apple juice.

These initial experiments identified that WPI does not work well in small amounts on its own as an additive for spray drying apple juice. The addition of 60 wt % maltodextrin was able to improve the spray-drying yields of apple juice significantly. However, the absolute yield was still approximately 20% lower than that for orange juice. The inventors found that at least 20 wt % WPI alone is required to achieve a yield of >60%. Overall, it was found that apple juice is much more difficult to spray dry than orange juice.

To achieve a better yield, further experiments with more WPI addition and other additives were conducted. The reason for the low effectiveness of WPI for spray drying apple juice compared to orange juice has been investigated.

### Investigation of WPI as Spray Drying Additives to Produce AJ Powders

In the preliminary experiments (Example 1), the addition of 1 wt % WPI did not improve the absolute yield from spray drying apple juice. However, many literature shows that WPI has the potential to improve this yield. It is believed that evaporation of water from the droplet surface causes concentration gradients. This concentration difference of protein between outmost layer and inside layer of particles provides a driving force of protein for coating the surface of particles. Therefore, by increasing the concentration of protein, the surface coating effectiveness value should increase as well.

In order to determine if WPI improves the yield from spray drying apple juice, another group of experiments, including 1 wt % and 10 wt % addition of WPI, were conducted. 100 wt % apple juice and 60 wt % addition of maltodextrin were used as control experiments.

These results showed that by increasing the concentration of WPI from 1 to 10 wt %, the yield increased significantly from around 1% to 7% as well. This proved that the WPI is also surface active for apple juice particles, but the yield is still too low for industry requirements (60%), and WPI does not work well enough for apple juice on its own.

The experimental work for orange juice (in Example 1) showed that WPI was effective in improving orange juice spray-drying yields. However, the results of experiments with WPI indicated that WPI was not as an effective additive for apple juice as it was for orange juice. This may be due to the fact that orange juice and apple juice have different characteristics, such as pH, solubility and composition, which can affect the effectiveness of additives in the spray-drying process. They have been investigated and discussed below. In particular, apple juice contains more fructose and malic acid, which will be discussed later. This was consistent with the evidence from the literature. Bhandari (2006) and Mari et al. (2001) suggested that fructose and malic acid were more sticky during spray drying than most other sugars and acids, respectively. The explanations for the different effects with WPI on spray drying orange juice and apple juice have been investigated further later.

Explanations of the Different Effect with WPI for Spray Drying OJ and AJ.

From the results above, it was found that WPI can improve the yield from spray drying orange juice significantly, but it does not work well for improving the yield from spray drying apple juice when used in the same amounts. The reasons have been analysed from the perspectives of solubility, pH and the differences in composition between apple juice and orange juice.

### pH Effect

Since the solubility of additives was affected by the pH of the solution, Konkol (2009) has suggested that the pH of fruit juice may be one of important factors for the selection of additives, since pH may ensure that the protein is properly dissolved. Two sets of pH tests were conducted to determine the pH of apple juice and orange juice solution used in these experiments.

TABLE A1
pH test results of apple juice.

| AJ | Sample 1 | Sample 2 | Sample 3 |
|---|---|---|---|
| Run 1 | 3 | 2.9 | 2.9 |
| Run 2 | 2.9 | 2.9 | 2.9 |

TABLE A2
pH test results of orange juice.

| OJ | Sample 1 | Sample 2 | Sample 3 |
|---|---|---|---|
| Run 1 | 2.7 | 2.7 | 2.7 |
| Run 2 | 2.7 | 2.7 | 2.6 |

Based on the pH test results for apple juice and orange juice shown in Table A1 and Table A2, respectively, the pH of apple juice was 2.9 and orange juice was 2.7 in these experiments. Based on the relationship between pH and solubility, the pH difference of 0.2 is unlikely to be significant in affecting the solubility of WPI in apple juice and orange juice. Moreover, based on the observation and tests in preparing the spray-drying samples, WPI can dissolve well in both apple juice and orange juice. Thus, neither of pH and solubility can affect the spray-drying efficiency significantly.

### Composition of AJ and OJ

The composition of apple juice and orange juice has been compared in Table 12.

TABLE 12
Comparisons of apple juice and orange juice composition and pH

| | Main | AJ (g/ | OJ (g/ | Tg | Density | |
|---|---|---|---|---|---|---|
| Symbol | Composition | 100 ml) | 100 ml) | (° C.) | (g/cm³) | Reference |
| 1 | Sucrose | 2.68 | 3.3 | 62 | 1.59 | (Mattick, |
| | | | | | | 1983; Bielig, |
| | | | | | | 1982) |
| 2 | Glucose | 2.07 | 2.8 | 31 | 1.54 | (Mattick, |
| | | | | | | 1983; Bielig, |
| | | | | | | 1982) |
| 3 | Fructose | 5.79 | 3 | 14 | 1.54 | (Mattick, |
| | | | | | | 1983) |
| 4 | Citric acid | 0.02 | 0.94 | 6 | 1.67 | (Gerin et al., |
| | | | | | | 1995; Bielig, |
| | | | | | | 1982) |
| 5 | Malic acid | 1 | 0.17 | −21 | 1.609 | (Briggs and |
| | | | | | | Seah, 1994) |

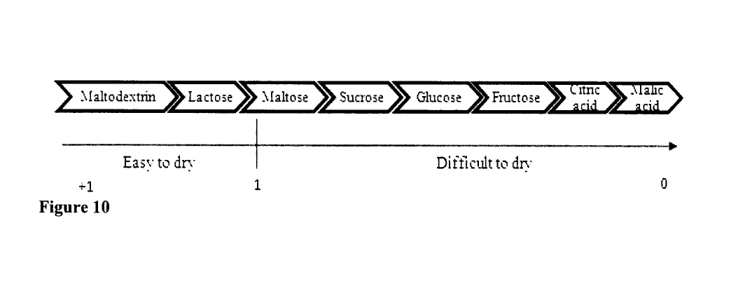

These five components are the main sugars and acids in apple juice and orange juice, and the glass-transition temperatures of them decrease from sucrose at the top of table to malic acid at the bottom. This order also reflects the order of component stickiness during spray drying, which is shown in FIG. 10.

Many experiments in the literature show the order of components in FIG. 10 being from easy to difficult to dry (Bhandari and Howes, 1999; Liu et al., 2006; Huntington and Stein, 2001). Therefore, it is more difficult to spray dry apple juice than orange juice, because there is more fructose and malic acid in apple juice than in orange juice.

However, there is more citric acid in orange juice than apple juice, thus a calculation for the overall glass-transition temperature of apple juice and orange juice was conducted to determine what components make the main contributions to the stickiness of juice.

For three or more solute components, the Couchman-Karasz quation was used to predict the overall glass-transition temperature. Thus, the overall glass transition temperature of apple juice and orange juice could be estimated as shown below (Couchman and Karasz, 1978),

$${T}_{g} = \frac{{w}_{1} Δ {C}_{p 1} {T}_{g 1} + {w}_{2} Δ {C}_{p 2} {T}_{g 2} + ⋯ + {w}_{5} Δ {C}_{p 5} {T}_{g 5}}{{w}_{1} Δ {C}_{p 1} + {w}_{2} Δ {C}_{p 2} + ⋯ + {w}_{5} Δ {C}_{p 5}} \qquad Equation 1$$

The following Equation 2 is derivation of Equation 1,

$${T}_{g} = \frac{{w}_{1} {T}_{g 1} + \frac{Δ {C}_{p 2}}{Δ {C}_{p 1}} {w}_{2} {T}_{g 2} + ⋯ + \frac{Δ {C}_{p 5}}{Δ {C}_{p 5}} {w}_{5} {T}_{g 5}}{{w}_{1} + \frac{Δ {C}_{p 2}}{Δ {C}_{p 1}} {w}_{2} + ⋯ + \frac{Δ {C}_{p 5}}{Δ {C}_{p 5}} {w}_{5}} \qquad Equation 2$$

since constant

$$K = \frac{Δ {C}_{pn}}{Δ {C}_{pn - 1}} ,$$

so Equation 2 can be written as follows.

$${T}_{g} = \frac{{w}_{1} {T}_{g 1} + {K}_{12} {w}_{2} {T}_{g 2} + ⋯ + {K}_{15} {w}_{5} {T}_{g 5}}{{w}_{1} + {K}_{12} {w}_{2} + ⋯ + {K}_{15} {w}_{5}} \qquad Equation 3$$

Based on the Simba-Boyer rule and

$${K}_{1 n} \approx \frac{{T}_{g 1} {ρ}_{p 1}}{{T}_{gn} {ρ}_{pn}}$$

### (Liu et al., 2006),

Thus, the overall glass transition temperature of apple juice and orange juice could be calculated from the data in Table 13. Furthermore, each term of K₁ₙwₙT_{gn} reflected the contribution of that component made to the overall glass-transition temperature. These results are shown in Table 13.

TABLE 13
The overall Tg and contribution from each components of apple juice and
orange juice.

| | Symbol | | | | | |
|---|---|---|---|---|---|---|
| | K₁₁W₁T_{g1} | K₁₂W₂T_{g2} | K₁₃W₃T_{g3} | K₁₄W₄T_{g4} | K₁₅W₅T_{g5} | T_{g} |
| | K₁₄w₄T_{g4} | | | | | T_{g} |
| Components | Sucrose | Glucose | Fructose | Citric acid | Malic acid | Overall |
| Tg (° C.) | 62 | 31 | 14 | 6 | −21 | |
| K₁ₙ | 1 | 1.14 | 1.21 | 1.14 | 1.31 | |
| Apple Juice, | 14.4 | 6.3 | 8.4 | 0 | −2.4 | 23.2 |
| K₁ₙwₙT_{gn} (° C.) | | | | | | |
| Contribution of | 54 | 24 | 32 | 0 | −9 | |
| Apple Juice (%) | | | | | | |
| Orange Juice | 20 | 9.7 | 5.0 | 0.6 | −0.5 | 31.2 |
| K₁ₙwₙT_{gn} (° C.) | | | | | | |
| Contribution of | 58 | 28 | 14 | 2 | −1 | |
| Orange Juice (%) | | | | | | |

From the results, the overall glass-transition temperature for apple juice (23.2° C.) is estimated to be much lower than that for orange juice (31.3° C.). Since Bhandari, Datta et al (1997b) stated that the glass-transition temperature is an indicator of stickiness in the spray-drying process, apple juice is harder to spray-dry than orange juice. This is corresponding to the preliminary experimental results, which show that the yields of spray-dried apple juice are lower than those of orange juice under the same circumstance, respectively. Thus, the different components and overall Tgs of apple juice and orange juice may be the reason for the difference between orange juice and apple juice yields.

To be more specific, and withour being bound by theory, the inventors believe the contribution percentage of fructose and malic acid in apple juice are significantly more than those in orange juice. Moreover, the inventors have found that fructose and malic acid are more difficult to be spray-dried than other components. Therefore, the lower yield with spray drying apple juice compared with orange juice may be caused by the larger amount of fructose and malic acid in apple juice than in orange juice.

### The Hybrid Additives of WPI and MD

As indicated hereinbefore (Table 11), the inventors have found that maltodextrin and WPI both have the ability to improve the yield of spray drying apple juice. The 60 wt % addition of maltodextrin and 10 wt % addition of WPI were able to achieve 47% and 7% yields, respectively. Therefore, it was suggested that 60 wt % MD and 10 wt % WPI both made contributions to improving the yield of spray drying apple juice. A solution with a composition of 40 wt % AJ:50 wt % MD:10 wt % WPI was designed to assess if the combination of MD and WPI was sufficient to give an industrially satisfactory yield. The results are shown in FIG. 13.

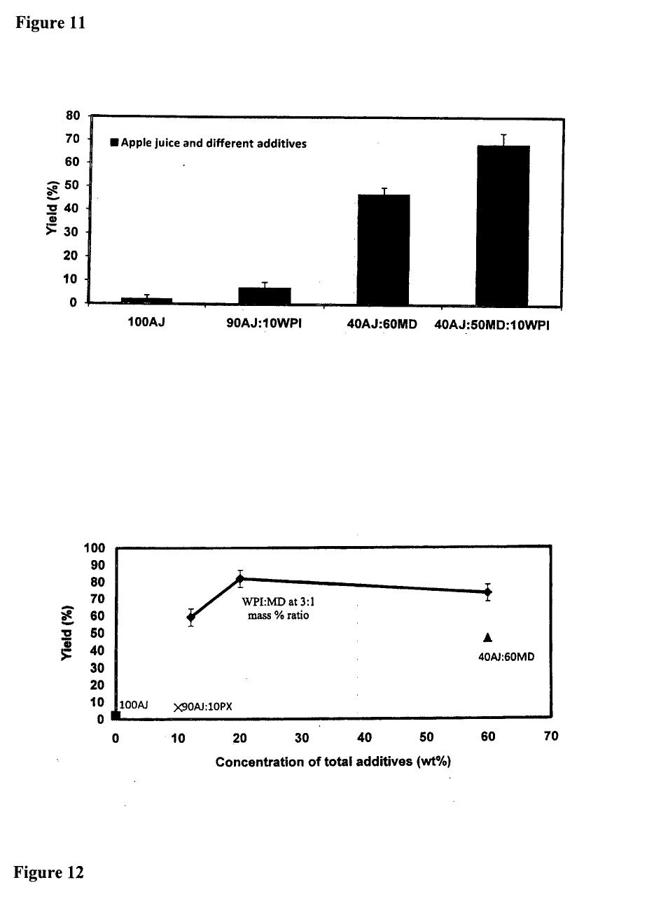

From FIG. 11, the yield of 40 AJ:50 MD:10 WPI was 68%, which was much higher than the yields of the control experiments. Moreover, this yield showed that the combination of MD and WPI functioned much better as an additive for spray drying apple juice than MD or WPI separately. This result was very important, because it showed that the combination of additives was effective for increasing the spray-drying yield significantly. Further experiments using different hybrids of MD and WPI were designed and investigated to improve the yield of spray drying apple juice.

### Optimization of the Total Percentage of Combination Additives

To optimise the percentage of total additive, a new group of experiments were designed with increasing total additive from 12 wt %, 20 wt % to 60 wt %, whilst maintaining the ratio of WPI and MD constant at 3:1, with the remainder being apple juice. The results are shown in FIG. 14.

FIG. 12 shows that the yield was stable in the range 73-82% when the concentration of total additives ranged from 20 wt % to 60 wt %. This change from 73 to 82% is not significant in terms of the error bars and experimental uncertainties. However, the yield dropped sharply and significantly from 82% down to 59% while the concentration of total additives decreased from 20 wt % to 10 wt %.

Compared with the yields from the control experiments, the combination of WPI and MD is much more effective as an additive for spray drying apple juice than WPI and MD separately. The yield of spray drying apple juice dropped down to 59 wt % when the concentration of total additives decreased to 10 wt %. Therefore, 20 wt % of total additives may be regarded as the optimal concentration of additive to give good yields for spray drying apple juice, which is a relatively low weight percentage of additive (20%) and acceptable in industry. The reason for this may be that the apple juice droplets need enough amount of WPI to coat their surfaces. When the total weight percentage of hybrid additives is less than 20%, the weight percentage of MD is less than 5% and the weight percentage of WPI is less than 15% (WPI:MD=3:1 weight percentage ratio in FIG. 12). Therefore, for spray-drying apple juice, 5% for MD or 15% for WPI, is the limitation factor for the hybrid additive to be the most effective. Some further experiments were performed to prove that 5% for MD is the limited factor instead of 15% for WPI. For example, 15 WPI:5 MD:80 AJ has a yield of 80%, which is almost as good as the yield of 5 WPI:15 MD:80 AJ (82%) here. Hence, it is believed that at least 5% for MD is beneficial in helping WPI to overcome certain stickiness component in apple juice. This stickiness component may be fructose, which is difficult to be spray-dried by adding WPI only.

### Optimisation of the Ratio of MD and WPI in Hybrid Additives

The combination of MD and WPI can improve the yield of spray-drying apple juice significantly, however, it is not clear to what extent MD or WPI make their individual contributions to the yield. This ratio between MD and WPI in hybrid additives is another important factor to optimize the additives for achieving a better yield of spray-drying apple juice.

From the last sets of experiments, 20% was the optimal weight percentage of total additives for spray-drying apple juice. Based on this fact, a new set of experiments including 80 AJ:1 WPI:19MD, 80 AJ:5 WPI:15 MD, 80 AJ:10 WPI:10 MD, 80 AJ:15 WPI:5 MD, 80AJ:19 MD:1 WPI and 80 AJ:20 WPI:0 MD was conducted to investigate the contribution of WPI and MD and the optimal ratio of the two additives. The results confirmed that both WPI and maltodextrin achieved the best yield and illustrated how they work together as a combination additive for spray-drying apple juice. 15 WPI:5 MD was found to be the most effective composition of hybrid additives, improving the yield of spray-drying apple juice yield to as high as 82%.

FIG. 13 shows the effect of different combinations of WPI and MD on the yield when spray-drying apple juice. It is easy to report and explain these results by dividing then in to three sections: Firstly, it is the increase of yield from 1 WPI:19 MD to 5WPI:15MD.

Secondly, it is the stable yield from 5 WPI:15MD to 15WPI:5MD. Thirdly, it is the decrease of yield from 15 WPI:5MD to 20WPI:0MD.

Results and Explanations from (a) 1 WPI:19 MD to (b) 5WPI:15MD

In FIG. 13, increasing the concentration of protein, whilst maintaining a 20 wt % total WPI and MD total concentration, led to a significant increase in the absolute yield from 59 wt % (1WPI:19 MD:80 AJ) to 81 wt % (5 WPI:15 MD:80 AJ), when the concentration of WPI increased from 1 wt % to 5 wt %. In FIG. 16 (a), since there are not enough WPI in the bulk concentration and the surface of apple juice droplets, the more WPI were added, the more surface of droplets were covered. This suggested that WPI at low concentrations (1˜5%) was more effective and made more contributions than maltodextrin to increasing the yield of spray-drying 80 wt % apple juice.

Preliminary experiments suggested that the concentration of orange juice has no effect on the absolute yield. If the yield of spray-drying apple juice was assumed to be not affected by the apple juice concentration, the fact may be confirmed again by comparing these two results with the 47% yield of the control experiment containing 40 AJ:60 MD as well. Taking 1WPI:19 MD and 40 AJ:60 MD as an example, only 1% WPI made a contribution that was more than 41% MD that has increased the absolute yield by approximate 12%.

Results and Explanations from (b) 5WPI:15MD to (c) 15WPI:5MD

In FIG. 13, though the concentration of protein increased further from 5 wt % to 15 wt %, the yields stayed almost constant at around 80% with a slightly low yield of 76% for 10 WPI:10 MD. However, considering the standard deviation of 2.5%, the yields from 5 to 15% concentration of WPI were steady at around 75˜82%.

Furthermore, the observation of the main contribution to improving yield by WPI is consistent with previous work. Kim (1996) and Young (1993) reported that WPI had a coating effectiveness value of 72.2% for orange juice and 37% for anhydrous milk fat. The inventors' previous work confirmed the surface-active and film-forming properties of WPI to encapsulate orange juice components by achieving a spray-drying yield to greater than 80% with only 1 wt % WPI.

Therefore, in these experiments shown in FIG. 13, 5 wt % of WPI (5 WPI:15 MD) may have coated the majority of the surface of apple juice powder to give a good yield (81%), which shown in FIG. 14 (b). Then, in FIG. 14 (c), while increasing the weight percentage of WPI further to 15 wt % (15WPI:5MD), the percentage coverage of WPI on the apple juice particle may be not able to increase much further. This situation was explained by Adhikari (2007). He stated that the coating ability of protein is affected by surface tension. He also found that the surface tension required to create the new surface decreases while the concentration of WPI increases from 1 wt % to 5 wt %, however, the surface tension required to create the new surface remains the same when the concentration of WPI increased from 5 wt % to 10 wt %. The reason may be that 5 wt % bulk concentration resulted in the coverage of the majority or the entire surface. Extra WPI may create isolated pockets or iceberg of pure WPI (Holmberg et al., 2003). This may explain with increasing the concentration of WPI, why the yield increased significantly at low concentration of WPI from 1 to 5%, while keeping constant from 5 to 15 wt % of WPI. To test this hypothesis, a group of XPS measurements were conducted. The results showed that the percentage coverage of WPI on apple juice powder was almost constant at 92% when the concentration of WPI increased from 5 wt % to 15 wt %, which supported the hypothesis.

Results and Explanations from (c) 15 WPI:5MD to (d) 20WPI:0MD

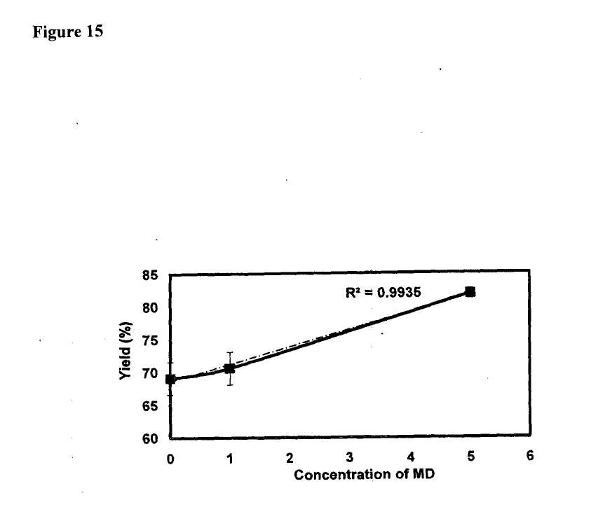

In FIG. 13, whilst still maintaining a 20 wt % WPI and MD total concentration, it was interesting to find that, when the concentration of WPI increased further from 15 wt % (15WPI:5 MD) to 20 wt % (20 WPI:0 MD), the yield dropped down steadily from 82% to 69%. These data confirmed last hypothesis that the concentration of WPI did not affect the spray-drying yield much at high concentrations of WPI (>5 wt %). It also showed that the yield decreased from 82% to 69% as the concentration of maltodextrin dropped from 5 wt % to 0. Therefore, there was a correlation between the concentration of maltodextrin and the yield based on the data from 15 WPI:5 MD, 19 WPI:1 MD and 20 WPI:0 MD, which is shown in FIG. 15. It showed that increasing concentration of maltodextrin from 0 to 5% in the presence of WPI had significant effect on absolute yield which means maltodextrin made contribution to achieve the best yield (82%) of spray-drying apple juice. The absolute yield of 20 WPI:0 MD was 69%, which was lower than the best yield (82%) of 15 WPI:5 MD, but still higher than industry requirement (60%) (Bhandari et al., 1997a). This result is promising in industry due to the fact that WPI is created as a by-product of cheese production and it is natural protein provide nutrition instead of maltodextrin. WPI is also has anti-inflammatory and anti-cancer properties. People and fruit juice companies prefer to have protein as the additives in fruit juices.

### Possible Mechanism Explanation

The hybrid additives of WPI and maltodextrin for spray drying apple juice may be explained by the differences in solubility and surface activity.

For solubility, it proposes that the less soluble components precipitates faster and form a coating layer on the surface of droplets. However, this was rejected by the experiments using WPI and soy protein acid hydrolysate from earlier experiments.

For the surface activity, Sheu and Rosenberg (1995) found that combinations of WPI and high DE maltodextrins are effective wall systems for microencapsulation of volatiles. In these systems, WPI was regarded as emulsifying and film-forming agent and maltodextrins were filters and matrix-forming agents. Therefore, in this particular case, the maltodextrin may be a filter or matrix-forming agent that, helps WPI to create a coating layer on the surface of apple juice components.

This result is different from the effect of maltodextrin on spray-drying orange juice. The inventors have found that increasing the concentration of maltodextrin concentration from <1 wt % to 50 wt % in presence of WPI had no significant effect on absolute yield, which was supported by regression analysis that provided an R2 value of 0.06 (p>0.01). This provides a contrast with the effect of maltodextrin on spray-drying apple juice. From the earlier explanations of the different effect with WPI on spray-drying apple juice and orange juice, much more fructose and malic acid, especially fructose, in apple juice may cause lower yields with spray drying apple juice compared with orange juice. WPI is effective in concentrations of about 20% wt, below this it may not be very effective on its own to reduce the stickiness of fructose, and maltodextrin can help WPI to reduce or overcome the stickiness of fructose.

This hypothesis is supported by the finding of Adhikari et al. (2003). The surface of a maltodextrin drop formed a skin which grew rapidly in thickness and transformed to a glassy state giving a non-sticky drop surface. Adhikari et al. (2003) also found that the addition of maltodextrin to the fructose solution reduced the surface stickiness of a fructose drop significantly. Bhandari et al. (1997a) stated that at least 50 wt % of maltodextrin DE12 was required to spray dry fructose, which is more difficult to be spray dry than other sugars. Therefore, one of hypothesis is that maltodextrin may be a surface active agent for fructose. Another hypothesis is that the maltodextrin, with a higher glass-transition temperature, mixes with fructose and changes the physical property of fructose drops resulting in higher overall higher glass-transition temperatures (Fox Jr and Flory, 1950). Thus, experiments using XPS have been performed to test the possible surface activity of maltodextrin. The spray-drying product for 40 AJ:60 MD was analysed and it showed that 82.3% of the surface of apple juice drops was coated by maltodextrin. This fact confirmed that maltodextrin is surface active agent and the first hypothesis is more reasonable.

Therefore, when the bulk concentrations of maltodextrin and WPI are high enough, such as 5WPI:15MD:80 AJ and 15WPI:5MD:80 AJ, the surface activity of hybrid additives are explanted in FIGS. 14 (b) and (c). WPI behaved like a “non-sticky pouch” because it formed a thickening smooth non-sticky skin on the surface of apple juice droplets during drying (Adhikari et al., 2009). However, there were some materials that are difficult to be coated by WPI, may be fructose. At the same time, maltodextrin mixed with WPI coated most the rest surface of droplets and formed a skin which grew rapidly in thickness and transformed to a glassy state giving a non-sticky drop surface. The WPI-MD film on the surface of apple juice droplet is smooth and non-sticky, therefore the stickiness of apple juice was overcome resulting spray-drying yields of more than 80%.

### Conclusions

The experiment aimed at using WPI at lower concentrations than those commonly used for maltodextrin as additives to spray dry apple juice with better yields. The results confirmed two more effective strategies with higher yields than 60% were developed as expected. The critical breakthrough was that the combination of 15% WPI and 5% MD was sufficient to increase the yield from 47±2.5% for currently-used 60% addition of maltodextrin 80±0.7%. Moreover, only adding WPI at a concentration of 20% can increase the yield of spray-drying apple juice to a greater value than 0%, which meets the industry requirement.

In spray-drying experiments, apple juice was quantitatively determined to be much more difficult spray dry than orange juice. It has previously been reported that WPI was an effective additive for spray-drying orange juice at low concentrations (1%) on its own. However, it was found here that WPI cannot improve the yield of spray-drying apple juice significantly on its own at low concentrations (≦10%) although it can improve the yields to some extent. This greater difficulty with apple juice results possibly from the existence of more fructose in apple juice than orange juice.

The integration of WPI and maltodextrin was very effective strategy for overcoming the stickiness of apple juice in spray drying. Two series experiments were performed to figure out the optimal hybrid additive the hybrid additive percentage (WPI+MD) to be 20% and the ratio between WPI and maltodextrin to be 3:1. It was also found that 15% WPI and 5% MD was the most effective additive with more than 80% yield, and 20% WPI was also an effective additive with more than 60% yield.

XPS techniques were used to investigate the surface properties of critical powder products from spray-drying experiments. Maltodextrin was found to overcome the stickiness of apple juice in spray-drying process by coating 82% the surface of juice droplets, even when its bulk concentration was 60%. This may due to maltodextrin having surface-active and film-forming properties or its relatively low diffusion coefficient. A “Surface composition calculation without oxygen” method was established, using surface-active WPI as an example, which was based on and improved Fäldt (1995)'s surface content matrix formula. It was also found that when maltodextrin and WPI worked as additives together, WPI had a stronger surface activity with a coating effectiveness of around 90% than maltodextrin, which means WPI made more contribution to improving the spray-drying yield of apple juice significantly than maltodextrin in hybrid additive.

Successful spray-drying of apple juice has been achieved than with a much higher yield than industry requirements. The hybrid additive of 15% WPI and 5% maltodextrin achieved more than 80% yield. The hybrid additive improved the productivity of apple juice powder significantly to meet the high demand for apple juice worldwide, as well as the need for longer shelf-lives and easier storage, handling and transport. A 20% addition of WPI alone increased the yield to greater than 60%, which is very promising as well. This is because WPI is a natural nutrient and is created as a by-product of cheese production. It is good for health and has anti-inflammatory and anti-cancer properties. Therefore, addition of WPI in fruit juice may be beneficial.

Furthermore, there is also potential to reduce the current costs of processing, since the amount of additive was reduced significantly from 60% for maltodextrin to 20% for either of two additive suggestions above in this work. This lower additive concentration means a higher purity fruit juice, which can retain the original and natural physicochemical properties of fruit juice better, such as texture, nutrition, flavour and fragrance. The finding of maltodextrin surface activity on the apple juice droplet is new and it helps to understand and explain why and how maltodextrin to improves the yield of spray drying. The “Surface composition calculation without oxygen” method can be applied to the determination of surface species composition in XPS measurement, it may give a more accurate result than that from Fäldt (1995)'s surface content matrix formula.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

### REFERENCES

Adhikari, B., Howes, T., Bhandari, B. R. & Langrish, T. A. G. (2009) Effect of Addition of Proteins on the Production of Amorphous Sucrose Powder through Spray Drying. Journal of Food Engineering, 94(2), 144-153.
Bhandari, B. R., Datta, N., Crooks, R., Howes, T. & Rigby, S. (1997a) A Semi-Empirical Approach to Optimise the Quantity of Drying Aids Required to Spray Dry Sugar-Rich Foods. Drying Technology, 15(10), 2509-2525.
Bhandari, B. R., Datta, N. & Howes, T. (1997b) Problems Associated with Spray Drying of Sugar-Rich Foods. Drying Technology, 15(2), 671-684.
Bhandari, B. R. & Howes, T. (1999) Implication of Glass Transition for the Drying and Stability of Dried Foods. Journal of Food Engineering, 40(1), 71-79.
Bielig, H. J., Faethe, W., Koch, J., Walirauch, S., and Wucherpfennig, K. (1982) Standard Values and Ranges of Specific Reference Number for Apple Juice, Grape Juice and Orange Juice. Fluessiges Obst, 49(177-186), 188-199.
Briggs, D. & Seah, M. S. (1994) Practical Surface Analysis, Auger and Xray Photoelectron Spectroscopy, John Wiley and Sons.
Couchman, P. R. & Karasz, F. E. (1978) A Classical Thermodynamic Discussion of the Effect of Composition on Glass-Transition Temperatures. Macromolecules, 11(1), 11.7-119.
Fäldt, P. (1995) Surface Composition of Spray Dried Emulsions. Department of Food Engineering. Lund University.
Fäldt, P., Bergenstahl, B. & Carlsson, G. (1993) The Surface Coverage of Fat on Food Powders Analysed by Esca\(Electron Spectroscopy for Chemical Food structure 12(2), 225-234
Gerin, P. A., Dengis, P. B. & Rouxhet, P. G. (1995) Performance of Xps Analysis of Model Biochemical Compounds. J. Chim. Phys, 92, 1043-1065.
Huntington, J. A. & Stein, P. E. (2001) Structure and Properties of Ovalbumin. Journal of Chromatography B: Biomedical Sciences and Applications, 756(1-2), 189-198,
Konkol, E. (2009) Spray Drying of Fruit Juice Using Proteins as Drying-Aids. School of Chemical and Biomolecular Engineering. Sydney, University of Sydney.
Liu, Y., Bhandari, B. & Zhou, W. (2006) Glass Transition and Enthalpy Relaxation of Amorphous Food Saccharides: A Review. Journal of Agricultural and Food Chemistry, 54(16), 5701-5717.
Mattick, L. R. M., J. C. (1983) Composition of Apple Juice. J. Assoc. Of Anal. Chem., 66, 1251-1255.
Shrestha, A. K., Ua-Arak, T., Adhikari, B. P., Howes, T. & Bhandari, B. R. (2007) Glass Transition Behavior of Spray Dried Orange Juice Powder Measured by Differential Scanning calorimetry (Dsc) and Thermal Mechanical Compression Test (Tmct). International Journal of Food Properties, 10(3), 661-673.

1. A powder food product comprising one or more fruit components or one or more vegetable components or combination thereof together with an amount of whey protein isolate effective to encapsulate the one or more fruit components or one or more vegetable components or combination thereof.

2. A The powder food product of claim 1 wherein the one or more fruit components are derived from one or more fruits selected from the group consisting of citrus fruits (including clementine, lime, grapefruit, mandarin, tangerine, kumquat, minneola, tangelo, lemon, orange and pummelo), apples, guavas, mangoes, lychee, berries (including blueberries blackberries, mulberries, strawberries, cranberries and gooseberries), bananas, pineapples, tomatoes, melons, peaches, nectarines, grapes, zucchini, figs, pears, melons, dates, papaya, persimmons, plums and apricots.

3. The powder food product of claim 1 wherein the one or more fruit components or one or more vegetable components or mixtures thereof is one or more fruit components only.

4. The powder food product of claim 1 where in the one or more fruit components is derived from one or more fruits selected from of the group consisting of oranges and apples.

5. The powder food product of claim 1 wherein the one or more fruit components or one or more vegetable components or mixtures thereof is one or more vegetable components only.

6. The powder food product of claim 1 wherein the one or more fruit components or one or more vegetable components or mixtures thereof is a combination of one or more fruit components and one or more vegetable components.

7. The powder food product of claim 1 wherein the one or more vegetable components is derived from one or vegetables selected from the group consisting of mushrooms, celery, carrots, beetroot, ginger, spinach, broccoli, cauliflower and zucchini.

8. The powder food product of claim 1 wherein at least one of the one or more fruit components or one or more vegetable components is derived from one or more fruits or vegetables having a pH of less than about 5.

9. The powder food product of claim 1 wherein at least one of the one or more fruit components or one or more vegetable components are derived from one or more fruits or vegetables having a pH of higher than about 5.

10. The powder food product of claim 1 wherein the one or more fruit components or one or more vegetable components or a mixture thereof is present in an amount of ≧40% w/w, preferably ≧45% w/w, preferably ≧50% w/w, preferably ≧55% w/w, more preferably ≧60% w/w, more preferably ≧65% w/w, more preferably ≧70% w/w, most preferably ≧75% w/w, preferably ≧80% w/w, preferably ≧85% w/w, preferably ≧90% w/w, preferably ≧95% w/w, and in an amount of ≦0.99% w/w.

11. The powder food product of claim 1, wherein the one or more fruit components or one or more vegetable components or a mixture thereof is present in an amount of about 40% w/w, about 70% w/w, about 80% w/w, about 90% w/w, about 95% w/w, about 98% w/w or about 99% w/w.

12. The powder food product of claim 1 wherein the whey protein isolate is present in an amount of ≦50% w/w, preferably ≦45% w/w, preferably ≦40% w/w, preferably ≦35% w/w, preferably ≦30% w/w, preferably ≦25% w/w, preferably ≦20% w/w, preferably ≦15% w/w, preferably ≦10% w/w, preferably ≦5% w/w, preferably ≦4% w/w, preferably ≦3% w/w, preferably ≦2% w/w, preferably ≦1% w/w, preferably ≦0.5% w/w, and in an amount of ≧0.01% w/w.

13. The powder food product of claim 1 wherein the whey protein isolate is present in an amount of ≧0.01% w/w, preferably ≧0.02% w/w, preferably ≧0.05% w/w, preferably ≧0.75% w/w, preferably ≧0.1% w/w, preferably ≧0.2% w/w, preferably ≧0.3% w/w, preferably ≧0.4% w/w, preferably ≧0.5% w/w, preferably ≧0.6% w/w, preferably ≧0.7% w/w preferably ≧0.8% w/w, preferably ≧0.9% w/w, preferably ≧1% w/w, and in an amount of ≦50% w/w.

14. The powder food product of claim 1 wherein the amount of whey protein isolate is present in an amount of about 0.01-50% w/w, preferably about 0.02-45% w/w, preferably about 0.05-40% w/w, preferably about 0.75-35% w/w, preferably about 0.1-30% w/w, preferably about 0.2-30% w/w, preferably about 0.3-30% w/w, preferably about 0.4-30% w/w, preferably about 0.5-30% w/w, preferably about 0.6-30% w/w, preferably about 0.7-30% w/w, preferably about 0.8-30% w/w, preferably about 0.9-30% w/w, preferably about 1.0-30% w/w, preferably about 0.1-25% w/w, preferably about 0.2-25% w/w, preferably about 0.3-25% w/w, preferably about 0.4-25% w/w, preferably about 0.5-25% w/w, preferably about 0.6-25% w/w, preferably about 0.7-25% w/w, preferably about 0.8-25% w/w, preferably about 0.9-25% w/w, preferably about 1.0-25% w/w, preferably about 0.1-20% w/w, preferably about 0.2-20% w/w, preferably about 0.3-20% w/w, preferably about 0.4-20% w/w, preferably about 0.5-20% w/w, preferably about 0.6-20% w/w, preferably about 0.7-20% w/w, preferably about 0.8-20% w/w, preferably about 0.9-20% w/w, preferably about 1.0-20% w/w.

15. The powder food product of claim 1 wherein the whey protein isolate is the sole additive.

16. The powder food product of claim 1 wherein the whey protein isolate is present in an amount of about 0.5% w/w-10%% w/w, preferably 0.5-5% w/w, preferably 0.5-2% w/w.

17. The powder food product of claim 1 wherein the whey protein isolate is present in an amount of about 0.5% w/w, preferably about 1.0% w/w, preferably about 2.5% w/w, preferably about 5.0% w/w, preferably about 10% w/w.

18. The powder food product of claim 15 wherein fruit components are derived from orange, preferably orange juice.

19. The powder food product of claim 1 wherein the whey protein isolate is present in an amount of about 20-50% w/w, preferably about 20-45% w/w, preferably, 20-40% w/w, preferably, 20-35% w/w, preferably 20-30% w/w, preferably 20-25% w/w, preferably about 20% w/w.

20. The powder food product of claim 19 wherein the fruit components are derived from apple, preferably apple juice.

21. The powder food product of claim 1 further comprising one or more extraneous additives.

22. The powder food product of claim 21 wherein the one or more extraneous additives are selected from the group consisting of maltodextrin, gum arabic and preservatives.

23. The powder food product of claim 21 wherein the extraneous additives are present in an amount of ≦about 50% w/w, preferably ≦about 45% w/w, preferably ≦about 40% w/w, preferably ≦about 35% w/w, preferably ≦about 30% w/w, preferably ≦about 25% w/w, preferably ≦about 20% w/w, preferably ≦about 15% w/w, preferably ≦about 10% w/w, preferably ≦about 5% w/w, preferably ≦about 4% w/w, preferably ≦about 3% w/w, preferably ≦about 2% w/w, preferably ≦about 1% w/w, most preferably ≦about 0.5% w/w, ≦0.1% w/w, and in an amount of ≧0.01% w/w.

24. The powder food product of claim 21 wherein the extraneous additive is present in an amount of about 0.01-20% w/w, preferably about 0.1-15% w/w, preferably about 0.2-10% w/w, preferably about 0.4-8% w/w, preferably about 0.5-5% w/w, preferably about 5% w/w, preferably about 2.5% w/w, preferably about 1% w/w, preferably about 0.5% w/w.

25. The powder food product of claim 21 wherein the extraneous additive is maltodextrin.

26. The powder food product of claim 21 comprising about 0.5 to 20% w/w maltodextrin and about 0.05 to 20% whey protein isolate, preferably about 0.5 to 5.0% w/w maltodextrin and about 0.5 to 5% w/w whey protein isolate, preferably 1-20% w/w maltodextrin and 1-20% whey protein isolate.

27. The powder food product of claim 21 comprising 50% maltodextrin and 10% whey protein isolate, preferably about 20% w/w maltodextrin and about 10% w/w whey protein isolate.

28. The powder food product of claim 21 wherein the total amount of additive is about 20%.

29. The powder food product of claim 28 comprising about 19% w/w maltodextrin and about 1% w/w whey protein isolate, preferably about 15% w/w maltodextrin and about 5% w/w whey protein isolate, preferably about 10% w/w maltodextrin and about 10% w/w whey protein isolate, preferably about 5% w/w maltodextrin and about 15% w/w whey protein isolate, preferably about 5% w/w maltodextrin and about 15% w/w whey protein isolate, preferably about 1% w/w maltodextrin and about 19% w/w whey protein isolate, preferably about 20% whey protein isolate.

30. The powder food product of claim 21 wherein the total amount of additive is about 1-10%.

31. The powder food product of claim 30 comprising about 0.5% w/w maltodextrin and about 0.5% w/w whey protein isolate, preferably about 1% w/w maltodextrin and about 1% w/w whey protein isolate, preferably about 2.5% w/w maltodextrin and about 2.5% w/w whey protein isolate, preferably about 5% w/w maltodextrin and about 5% w/w whey protein isolate, preferably about 1% w/w whey protein isolate.

32. Use of a powder food product of claim 1 in the preparation of a reconstituted food product.

33. Use according to claim 32 wherein the powder food product is reconstituted with a liquid, preferably water or water based.

34. Use of a whey protein isolate in the preparation of a powder food product comprising one or more fruit components or vegetable components or combinations thereof.

35. A method of manufacturing a powder food product comprising a whey protein isolate and one or more fruit components or vegetable components or combinations thereof, the method comprising preparing a solution of one or more fruit and/or vegetable juices and whey protein isolate and spraying drying the solution to form the powder food product.

36. The method of claim 35 wherein the powder food product is as defined in claim 1 and wherein the one or more fruit components or one or more vegetable components or combinations thereof are derived from one or more fruit juices or one or more vegetable juices or combinations thereof.

37. The method of claim 35 wherein the solution is prepared by dissolving the whey protein isolate in water to form a solubilised protein, followed by mixing the solubilised protein with the one or more fruit juices or one or more vegetable juices or mixtures thereof.

38. The method of claim 37 wherein the water is at a temperature of about 22° C.-26° C.

39. The method of claim 35 wherein the whey protein isolate is first dissolved in the one or more fruit juices or one or more vegetable juices or combinations thereof, preferably at a temperature of about 22° C.-26° C.

40. The method of claim 35 wherein the juice is extracted from one or more fruits or one or more vegetables or mixtures thereof.

41. The method of claim 35 wherein the juice is in a concentrated or non-concentrated form.

42. The method of claim 35 wherein the fruit or vegetable juice is treated to remove pulp and other solids.

43. The method of claim 35 wherein the fruit or vegetable juice is not treated to remove pulp and other solids.

44. The method of claim 35 wherein a solution of whey protein isolate and fruit or vegetable juice or mixtures thereof is fed into a spray drying machine with an inlet temperature of about 100-230° C., preferably about 130-220° C., more preferably 160-190° C., preferably about 130° C.

45. The method of claim 44 wherein the spray drying machine has an outlet temperature of about 80-120° C., preferably about 100° C.
